(19) United States
(12) Patent Application Publication
(10) Pub. No.: US 2025/0203427 A1
(43) Pub. Date: Jun. 19, 2025

(54) PER PATH DOPPLER REPORTING BASED ON TRACKING REFERENCE SIGNAL

(71) Applicant: QUALCOMM Incorporated, San Diego, CA (US)

(72) Inventors: Muhammad Sayed Khairy ABDELGHAFFAR, San Jose, CA (US); Yu ZHANG, San Diego, CA (US); Yi HUANG, San Diego, CA (US); Alexandros MANOLAKOS, Athens (GR); Wanshi CHEN, San Diego, CA (US)

(21) Appl. No.: 18/843,095

(22) PCT Filed: Apr. 4, 2023
(86) PCT No.: PCT/US2023/017444

§ 371 Date: Aug. 30, 2024

(30) Foreign Application Priority Data
Apr. 18, 2022 (GR) 20220100334

(51) Int. Cl. H04W 24/10; H04L 5/00

(52) U.S. Cl. CPC H04W 24/10; H04L 5/0048

(57) ABSTRACT

Various aspects of the present disclosure generally relate to wireless communication. In some aspects, a user equipment (UE) may receive, from a network entity, a Doppler measurement report configuration. The UE may receive, from the network entity, a tracking reference signal (TRS). The UE may transmit, to the network entity, a Doppler measurement report in accordance with the Doppler measurement report configuration, wherein the Doppler measurement report indicates per path or per path-group Doppler frequency and Doppler frequency power measurements performed on the TRS, for one or more paths or path-groups. Numerous other aspects are described.

### CROSS-REFERENCE TO RELATED APPLICATION

This Patent application claims priority to Greece Patent Application Serial No. 20220100334, filed on Apr. 18, 2022, entitled “PER PATH DOPPLER REPORTING BASED ON TRACKING REFERENCE SIGNAL,” and assigned to the assignee hereof. The disclosure of the prior application is considered part of and is incorporated by reference into this Patent Application.

### FIELD OF THE DISCLOSURE

Aspects of the present disclosure generally relate to wireless communication and to techniques and apparatuses for per path Doppler reporting based on a tracking reference signal (TRS).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of physical channels and reference signals in a wireless network, in accordance with the present disclosure.

FIG. 5 is a diagram illustrating examples of downlink channel and precoder prediction using tracking reference signal (TRS) measurements, in accordance with the present disclosure.

FIG. 6 is a diagram illustrating an example of a TRS configuration, in accordance with the present disclosure.

FIGS. 7A-7G and 8 are diagrams illustrating examples associated with per path Doppler reporting based on a TRS, in accordance with the present disclosure.

FIGS. 9-10 are diagrams illustrating example processes associated with per path Doppler reporting based on a TRS, in accordance with the present disclosure.

FIGS. 11-12 are diagrams of example apparatuses for wireless communication, in accordance with the present disclosure.

### SUMMARY

Some aspects described herein relate to a user equipment (UE) for wireless communication. The UE may include a memory and one or more processors coupled to the memory. The one or more processors may be configured to receive, from a network entity, a Doppler measurement report configuration. The one or more processors may be configured to receive, from the network entity, a tracking reference signal (TRS). The one or more processors may be configured to transmit, to the network entity, a Doppler measurement report in accordance with the Doppler measurement report configuration, wherein the Doppler measurement report indicates per path or per path-group Doppler frequency and Doppler frequency power measurements performed on the TRS, for one or more paths or path-groups.

Some aspects described herein relate to a network entity for wireless communication. The network entity may include a memory and one or more processors coupled to the memory. The one or more processors may be configured to transmit a Doppler measurement report configuration. The one or more processors may be configured to transmit a TRS. The one or more processors may be configured to receive a Doppler measurement report associated with a UE in accordance with the Doppler measurement report configuration, wherein the Doppler measurement report indicates per path or per path-group Doppler frequency and Doppler frequency power measurements performed on the TRS, for one or more paths or path-groups.

Some aspects described herein relate to a method of wireless communication performed by a UE. The method may include receiving, from a network entity, a Doppler measurement report configuration. The method may include receiving, from the network entity, a TRS. The method may include transmitting, to the network entity, a Doppler measurement report in accordance with the Doppler measurement report configuration, wherein the Doppler measurement report indicates per path or per path-group Doppler frequency and Doppler frequency power measurements performed on the TRS, for one or more paths or path-groups.

Some aspects described herein relate to a method of wireless communication performed by a network entity. The method may include transmitting a Doppler measurement report configuration. The method may include transmitting a TRS. The method may include receiving a Doppler measurement report associated with a UE in accordance with the Doppler measurement report configuration, wherein the Doppler measurement report indicates per path or per path-group Doppler frequency and Doppler frequency power measurements performed on the TRS, for one or more paths or path-groups.

Some aspects described herein relate to a non-transitory computer-readable medium that stores a set of instructions for wireless communication by a UE. The set of instructions, when executed by one or more processors of the UE, may cause the UE to receive, from a network entity, a Doppler measurement report configuration. The set of instructions, when executed by one or more processors of the UE, may cause the UE to receive, from the network entity, a TRS. The set of instructions, when executed by one or more processors of the UE, may cause the UE to transmit, to the network entity, a Doppler measurement report in accordance with the Doppler measurement report configuration, wherein the Doppler measurement report indicates per path or per path-group Doppler frequency and Doppler frequency power measurements performed on the TRS, for one or more paths or path-groups.

Some aspects described herein relate to a non-transitory computer-readable medium that stores a set of instructions for wireless communication by a network entity. The set of instructions, when executed by one or more processors of the network entity, may cause the network entity to transmit a Doppler measurement report configuration. The set of instructions, when executed by one or more processors of the network entity, may cause the network entity to transmit a TRS. The set of instructions, when executed by one or more processors of the network entity, may cause the network entity to receive a Doppler measurement report associated with a UE in accordance with the Doppler measurement report configuration, wherein the Doppler measurement report indicates per path or per path-group Doppler frequency and Doppler frequency power measurements performed on the TRS, for one or more paths or path-groups.

Some aspects described herein relate to an apparatus for wireless communication. The apparatus may include means for receiving, from a network entity, a Doppler measurement report configuration. The apparatus may include means for receiving, from the network entity, a TRS. The apparatus may include means for transmitting, to the network entity, a Doppler measurement report in accordance with the Doppler measurement report configuration, wherein the Doppler measurement report indicates per path or per path-group Doppler frequency and Doppler frequency power measurements performed on the TRS, for one or more paths or path-groups.

Some aspects described herein relate to an apparatus for wireless communication. The apparatus may include means for transmitting a Doppler measurement report configuration. The apparatus may include means for transmitting a TRS. The apparatus may include means for receiving a Doppler measurement report associated with a UE in accordance with the Doppler measurement report configuration, wherein the Doppler measurement report indicates per path or per path-group Doppler frequency and Doppler frequency power measurements performed on the TRS, for one or more paths or path-groups.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

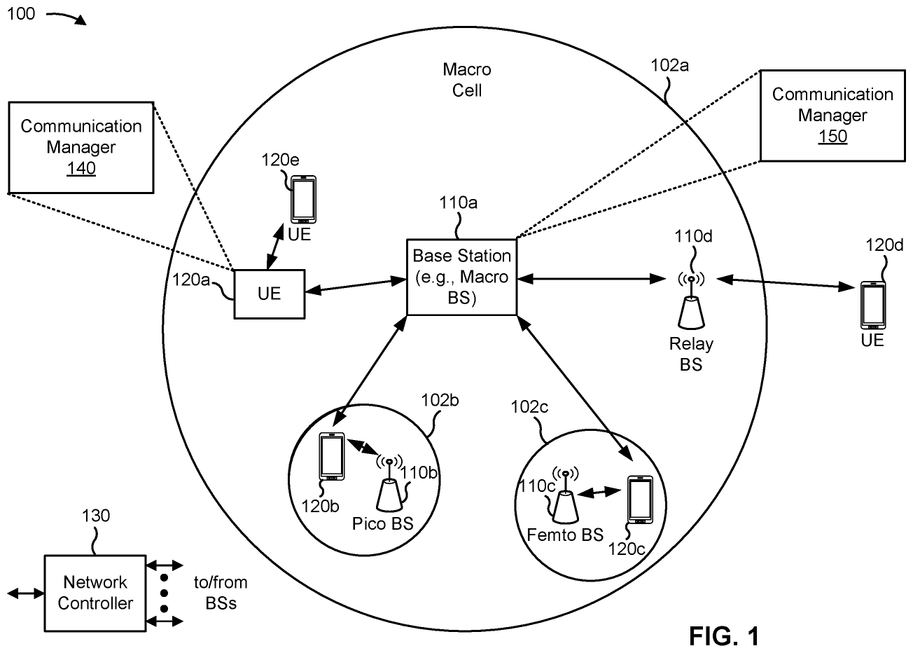

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay network node, a relay node, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link or a midhaul communication link. The base stations 110 may communicate with one another directly or indirectly via a wireless or wireline backhaul communication link. In some aspects, the network controller 130 may be a central or centralized unit (CU) or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz).

Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, from a network entity, a Doppler measurement report configuration; receive, from the network entity, a tracking reference signal (TRS); and transmit, to the network entity, a Doppler measurement report in accordance with the Doppler measurement report configuration, wherein the Doppler measurement report indicates per path or per path-group Doppler frequency and power measurements performed on the TRS, for one or more paths or path-groups. Additionally, or alternatively, the communication manager 140 may perform one or more other operations described herein.

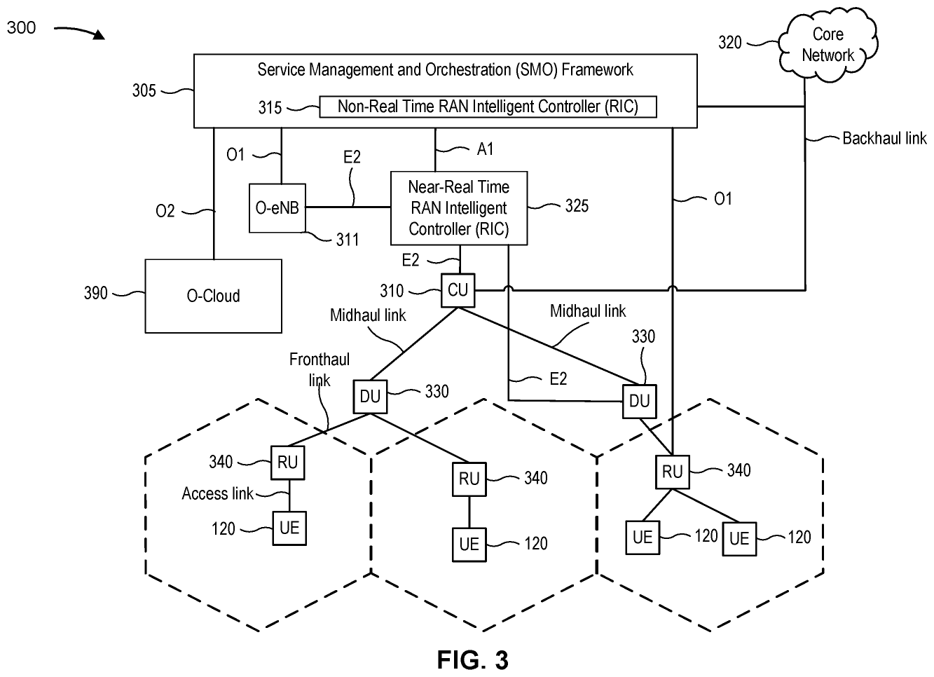

In some aspects, a network entity (e.g., a base station 110 or one or more components described in connection with FIG. 3) may include a communication manager 150. As described in more detail elsewhere herein, the communication manager 150 may transmit a Doppler measurement report configuration; transmit a TRS; and receive a Doppler measurement report associated with a UE in accordance with the Doppler measurement report configuration, wherein the Doppler measurement report indicates per path or per path-group Doppler frequency and power measurements performed on the TRS, for one or more paths or path-groups. Additionally, or alternatively, the communication manager 150 may perform one or more other operations described herein.

As indicated above, FIG. 1 is provided as an example. Other examples may differ from what is described with regard to FIG. 1.

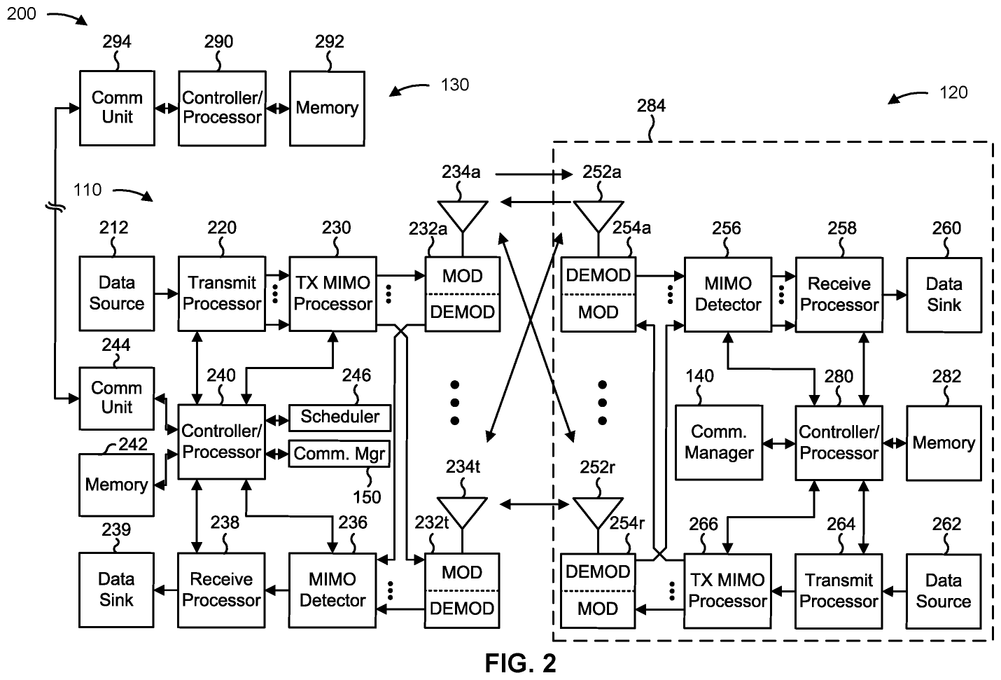

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

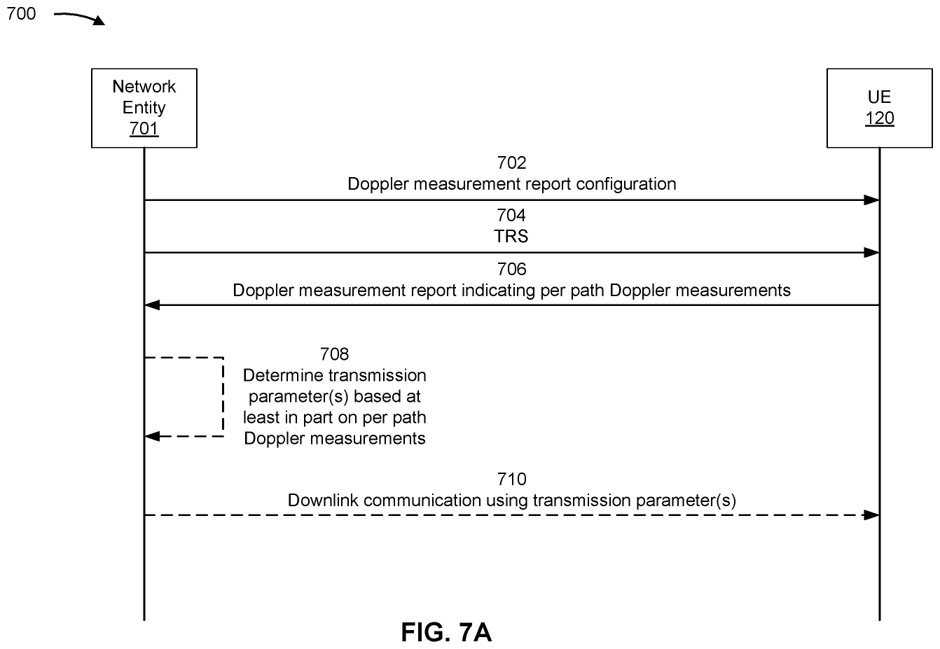

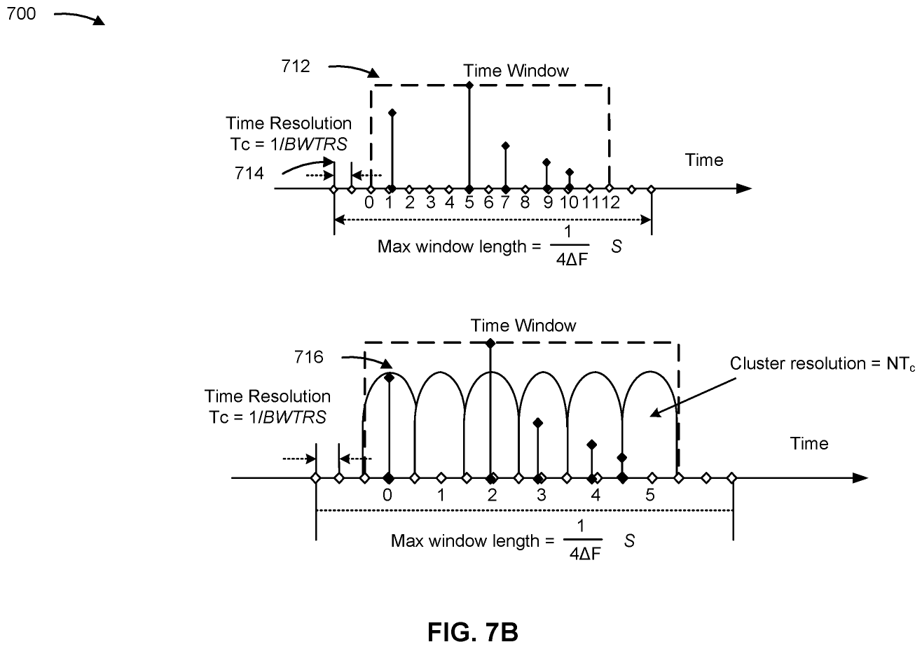

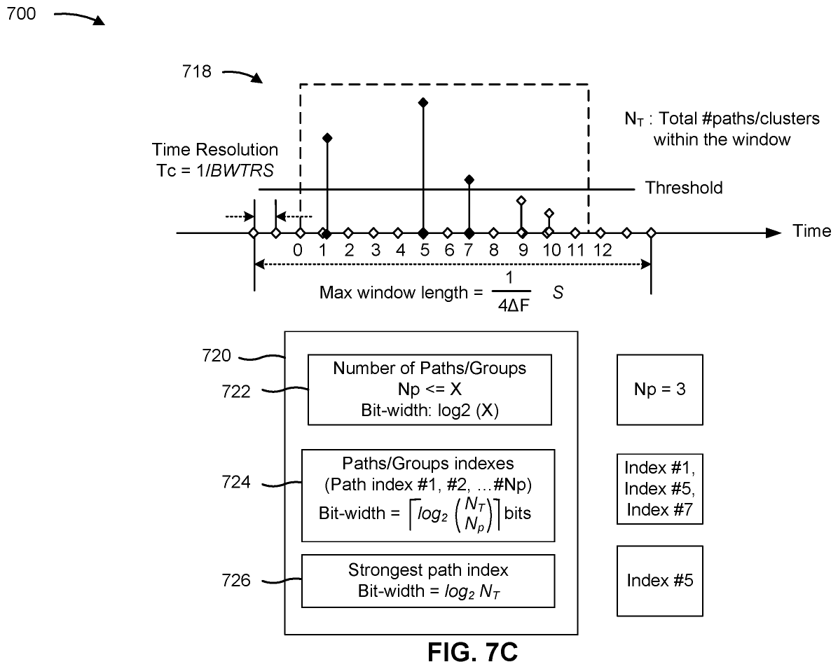

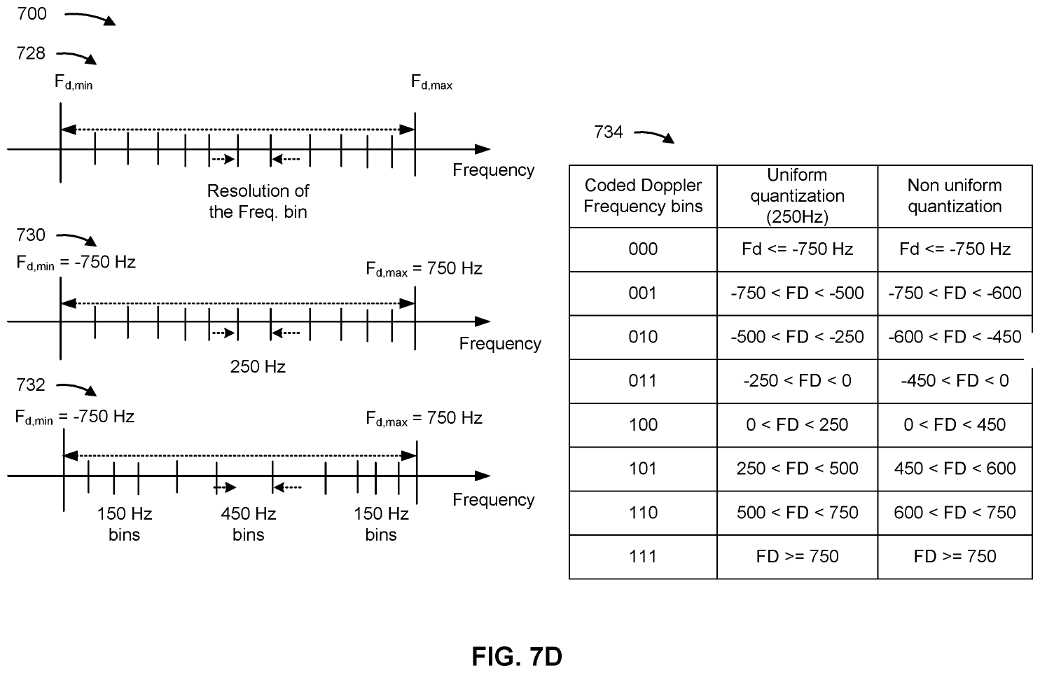

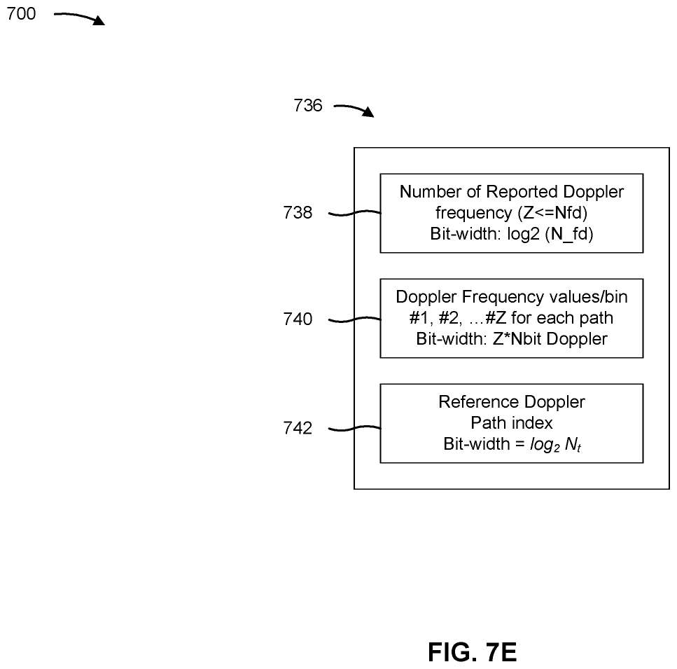

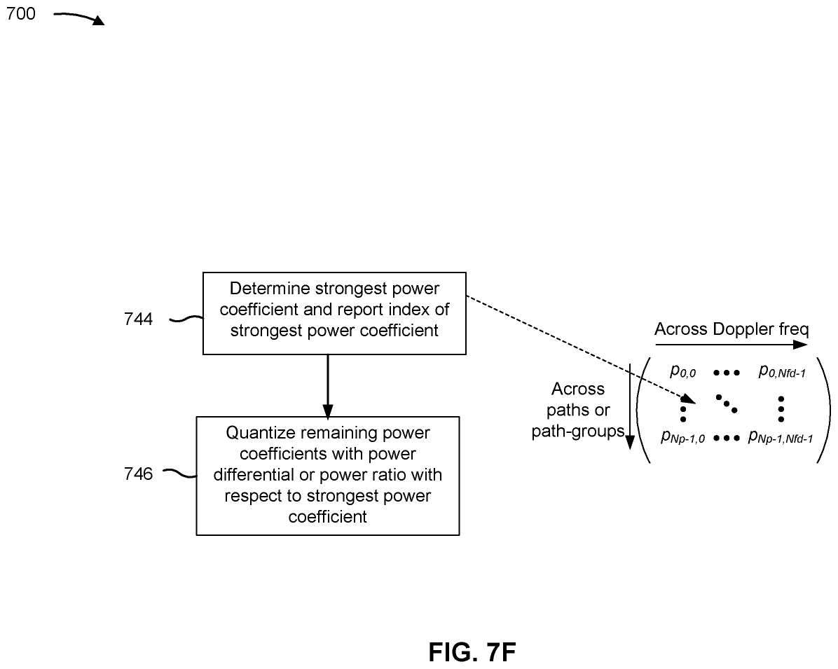

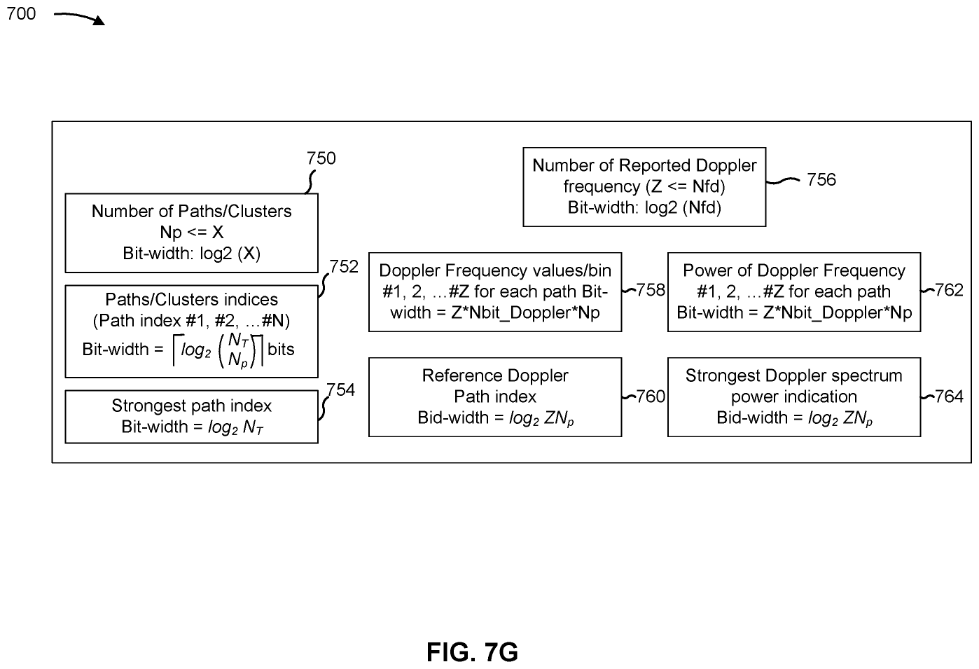

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7A-7G and 8-12).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7A-7G and 8-12).

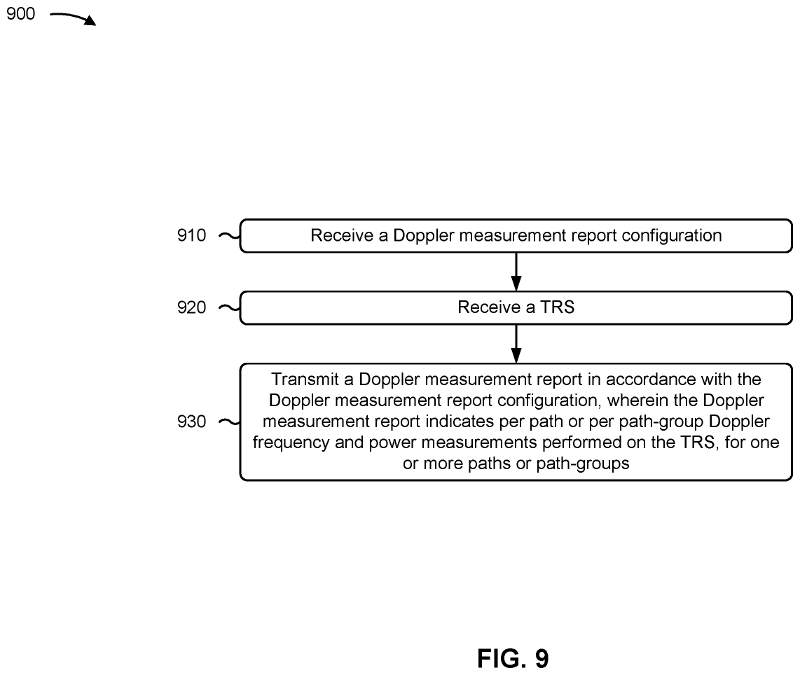

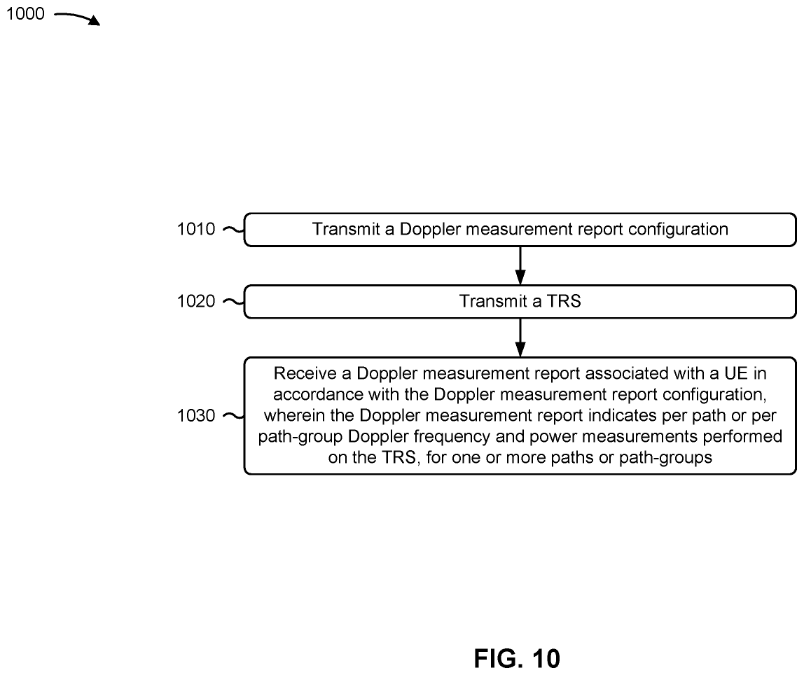

The controller/processor 240 of the base station 110, the controller/processor 280 of the UE 120, and/or any other component(s) of FIG. 2 may perform one or more techniques associated with per path Doppler reporting based on a TRS, as described in more detail elsewhere herein. For example, the controller/processor 240 of the base station 110, the controller/processor 280 of the UE 120, and/or any other component(s) of FIG. 2 may perform or direct operations of, for example, process 900 of FIG. 9, process 1000 of FIG. 10, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 900 of FIG. 9, process 1000 of FIG. 10, and/or other processes as described herein. In some examples, executing instructions may include running the instructions, converting the instructions, compiling the instructions, and/or interpreting the instructions, among other examples. In some aspects, the network entity described herein is the base station 110, is included in the base station 110, or includes one or more components of the base station 110 shown in FIG. 2.

In some aspects, the UE 120 includes means for receiving, from a network entity, a Doppler measurement report configuration; means for receiving, from the network entity, a TRS; and/or means for transmitting, to the network entity, a Doppler measurement report in accordance with the Doppler measurement report configuration, wherein the Doppler measurement report indicates per path or per path-group Doppler frequency and power measurements performed on the TRS, for one or more paths or path-groups. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity includes means for transmitting a Doppler measurement report configuration; means for transmitting a TRS; and/or means for receiving a Doppler measurement report associated with a UE in accordance with the Doppler measurement report configuration, wherein the Doppler measurement report indicates per path or per path-group Doppler frequency and power measurements performed on the TRS, for one or more paths or path-groups. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more distributed units (DUs), or one or more radio units (RUs)). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

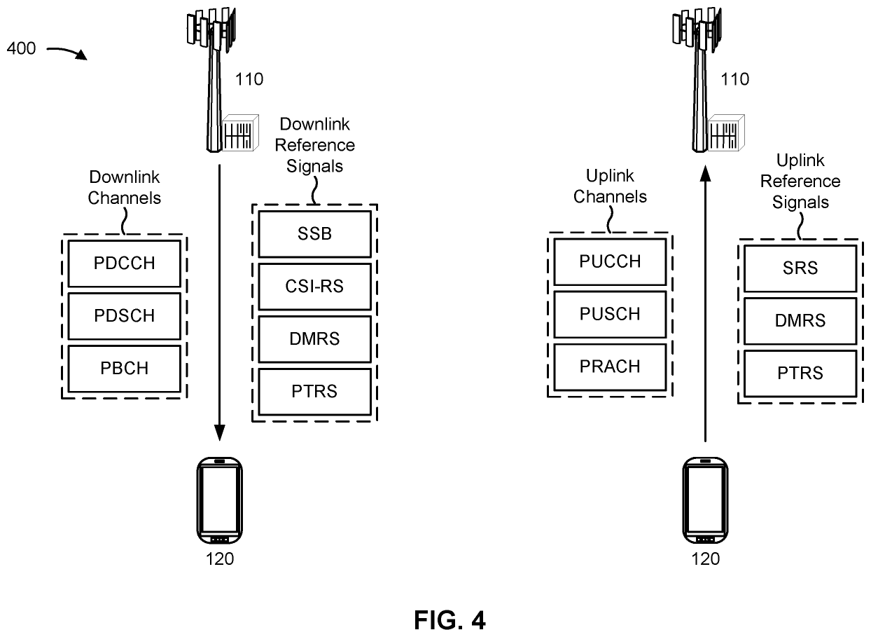

FIG. 4 is a diagram illustrating an example 400 of physical channels and reference signals in a wireless network, in accordance with the present disclosure. As shown in FIG. 4, downlink channels and downlink reference signals may carry information from a base station 110 to a UE 120, and uplink channels and uplink reference signals may carry information from a UE 120 to a base station 110.

As shown, a downlink channel may include a physical downlink control channel (PDCCH) that carries downlink control information (DCI), a physical downlink shared channel (PDSCH) that carries downlink data, or a physical broadcast channel (PBCH) that carries system information, among other examples. In some aspects, PDSCH communications may be scheduled by PDCCH communications. As further shown, an uplink channel may include a physical uplink control channel (PUCCH) that carries uplink control information (UCI), a physical uplink shared channel (PUSCH) that carries uplink data, or a PRACH used for initial network access, among other examples. In some aspects, the UE 120 may transmit acknowledgement (ACK) or negative acknowledgement (NACK) feedback (e.g., ACK/NACK feedback or ACK/NACK information) in UCI on the PUCCH and/or the PUSCH.

As further shown, a downlink reference signal may include a synchronization signal block (SSB), a channel state information (CSI) reference signal (CSI-RS), a DMRS, a positioning reference signal (PRS), or a phase tracking reference signal (PTRS), among other examples. As also shown, an uplink reference signal may include a sounding reference signal (SRS), a DMRS, or a PTRS, among other examples.

An SSB may carry information used for initial network acquisition and synchronization, such as a PSS, an SSS, a PBCH, and a PBCH DMRS. An SSB is sometimes referred to as a synchronization signal/PBCH (SS/PBCH) block. In some aspects, the base station 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The base station 110 may configure a set of CSI-RSs for the UE 120, and the UE 120 may measure the configured set of CSI-RSs. Based at least in part on the measurements, the UE 120 may perform channel estimation and may report channel estimation parameters to the base station 110 (e.g., in a CSI report), such as a CQI, a precoding matrix indicator (PMI), a CSI-RS resource indicator (CRI), a layer indicator (LI), a rank indicator (RI), or an RSRP, among other examples. The base station 110 may use the CSI report to select transmission parameters for downlink communications to the UE 120, such as a number of transmission layers (e.g., a rank), a precoding matrix (e.g., a precoder), an MCS, or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A PRS may carry information used to enable timing or ranging measurements of the UE 120 based on signals transmitted by the base station 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring base stations in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. In some aspects, the base station 110 may then calculate a position of the UE 120 based on the RSTD measurements reported by the UE 120.

An SRS may carry information used for uplink channel estimation, which may be used for scheduling, link adaptation, precoder selection, or beam management, among other examples. The base station 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The base station 110 may measure the SRSs, may perform channel estimation based at least in part on the measurements, and may use the SRS measurements to configure communications with the UE 120.

As indicated above, FIG. 4 is provided as an example. Other examples may differ from what is described with regard to FIG. 4.

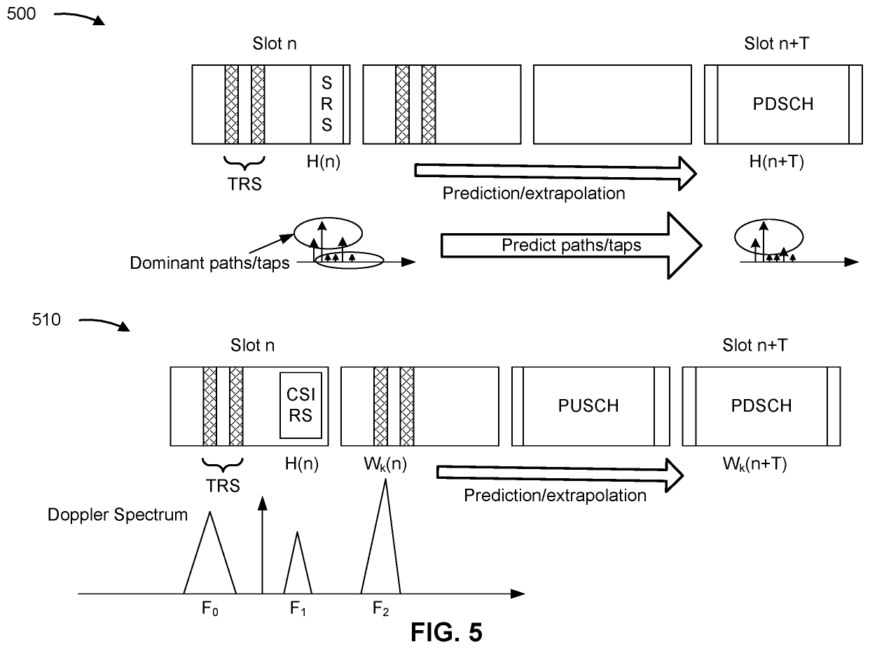

FIG. 5 is a diagram illustrating examples 500 and 510 of downlink channel and precoder prediction using TRS measurements, in accordance with the present disclosure.

In some examples, a network entity (e.g., a base station 110, CU 310, DU 330, RU 340, or a combination thereof) may determine a precoder for a downlink communication to a UE (e.g., UE 120) using reciprocity-based beamforming. In this case, the UE may transmit an SRS to the network entity in an uplink channel, and the network entity may perform channel estimation of based at least in part on measurements of the SRS. The network entity, based on reciprocity between downlink and uplink channels, may determine a precoder based at least in part on the SRS-based channel estimation, and the network entity may use the precoder for precoding a downlink communication (e.g., a PDSCH communication) to the UE in a later slot.

In some examples, a network entity may use codebook-based beamforming for determining a precoder for a downlink communication to a UE. In this case, the network entity may transmit a CSI-RS to a UE. The UE, based at least in part on measurements of the CSI-RS, may perform channel estimation and may select a downlink precoder. The UE may report the selected precoder to the network entity via an uplink channel (e.g., PUSCH or PUCCH), and the network entity may use the selected precoder for precoding a downlink communication (e.g., a PDSCH communication) to the UE in a later slot.

In both reciprocity-based beamforming and codebook-based beamforming, channel conditions at one time (e.g., in a first slot) are used to select a precoder for precoding a downlink communication at another time (e.g., in a second slot). However, in some cases, such as for UEs with high mobility (e.g., UEs traveling at high velocities), channel conditions may change between the channel estimation used to select the precoder and the transmission of a downlink communication precoded using the selected precoder. As a result, reliability of downlink communications may be reduced.

In some aspects, downlink precoding by the network entity may be enhanced by using time domain channel properties measured via TRS measurements by the UE to predict the downlink channel and/or the precoder at the transmission time of a downlink communication. In some aspects, the downlink channel and/or precoder predictions may be based at least in part on per-path Doppler frequency measurements performed on a TRS, for one or more paths. A “path” refers to a delay path of an impulse (or “tap”) of a set of impulses (or taps) for a measuring a channel impulse response in a time domain. That is, each path corresponds to a respective impulse (or tap), at a respective time, of a set of impulses (or taps) in the time domain. Hereinafter, “paths” and “taps” may be used interchangeably. Although a Rayleigh fading channel model (e.g., a tapped delay line (TDA) channel model, an extended pedestrian A (EPA) channel model, extended vehicular A (EVA) channel model, or the like) has the same Doppler spectrum for all paths, in a spatial channel model (e.g., a clustered delay line (CDL) channel model), as used in NR, each delay path is associated with a different Doppler spectrum. Thus, in some aspects, Doppler spectrum measurements of a TRS in different paths may provide time-domain channel properties which may be used for downlink channel and/or precoder prediction to improve downlink precoding.

As shown in FIG. 5, example 500 shows example of downlink channel prediction using TRS measurements for enhanced reciprocity-based downlink precoding. As shown in example 500, in some aspects, a network entity may perform downlink channel prediction or extrapolation, based at least in part on an estimated channel H(n) (from an SRS transmitted by a UE) at slot n and based at least in part on a UE-reported time domain correlation (e.g., Doppler shift) based on a TRS transmitted to the UE by the network entity, in order to predict the downlink channel H(n+T) at slot n+T. For example, the prediction of the downlink channel H(n+T) may be based at least in part on reciprocity between the DL TRS and the uplink SRS and a mapping between downlink channel taps/paths of the TRS and uplink channel taps/paths of the SRS. In some aspects, the UE may report, to the network entity, the mean or maximum Doppler frequency measured on the TRS for each of one or more dominant paths/taps (or paths/taps within a specified time window). The network entity may use the mean or maximum Doppler frequency for each dominant path/tap to extrapolate or predict the phase and magnitude of a corresponding tap at a future slot (e.g., slot n+T) for downlink PDSCH precoding. In some aspects, the network entity may perform the extrapolation/prediction assuming a per-tap Jakes Doppler spectrum. For example, the network entity may predict the measured channel h for each dominant path/tap at slot n+T as hₗ(n+T)=hₗ(n)×J₀(2πf_{d}(l),T), where J₀ is the per tap Doppler spectrum, fa is the maximum Doppler frequency, and l is the tap index. In some aspects, the network entity may perform the extrapolation/prediction based at least in part on a per path/tap Doppler shift. For example, the network entity may predict the measured channel h for each dominant path/tap at slot n+T as hₗ(n+T)=hₗ(n)×e^{i2πf}^{_{d}}^{(l)t}, where f_{d} is the per path/tap Doppler shift. For frequency domain channel extrapolation, the network entity may determine a time domain correlation matrix (Rtt) for extrapolating the channel H_{f}(n+T) based on the reported Doppler spectrum/shift and Doppler power (e.g., channel/path location in time may not be leveraged). For example, the network entity may determine the time domain correlation matrix Rtt as Rₜₜ=J₀(2πf_{d}_{ₘₐₓ},T) for the Jakes Doppler spectrum-based prediction or Rₜₜ=Σiαᵢe^{-2πf}^{ₛ}^{(i)t}J₀(2πf_{d}(i), T) for the Doppler shift-based prediction.

As further shown in FIG. 5, example 510 shows example of precoder prediction using TRS measurements for enhanced codebook-based downlink precoding. As shown in example 510, in some aspects, a network entity may perform precoder prediction/extrapolation, based at least in part on reported CSI (e.g., indicating a precoder W(n)) associated with a CSI-RS transmitted at slot n and based at least in part on a time-domain correlation shift of the channel based on a TRS, in order to predict a precoder W(n+T) for a PDSCH communication at slot n+T. The precoder W(n) may be selected based on an estimated channel H(n) from the CSI transmitted at slot n. In some aspects, the UE may report a codebook (e.g., a channel state feedback (CSF) report) based on the CSI-RS, and the UE may report per path/tap Doppler frequency measurements (e.g., Doppler spectrums F₀, F₁, and F₂ in FIG. 5) measured on the TRS for one or more dominant paths/taps. In some aspects, the network entity may perform the precoder extrapolation/prediction (in the frequency domain) in a similar manner to frequency domain channel impulse response (CIR). For example, the network entity may predict the Wₖ at slot n+T as Wₖ(n+T)=Wₖ(n)×e^{-2πf}^{ₛ}^{t}J₀(2πf_{DS},T) where fₛ is the doppler shift and f_{DS} is the maximum doppler spread of the Doppler spectrum.

As indicated above, FIG. 5 is provided as examples. Other examples may differ from what is described with regard to FIG. 5.

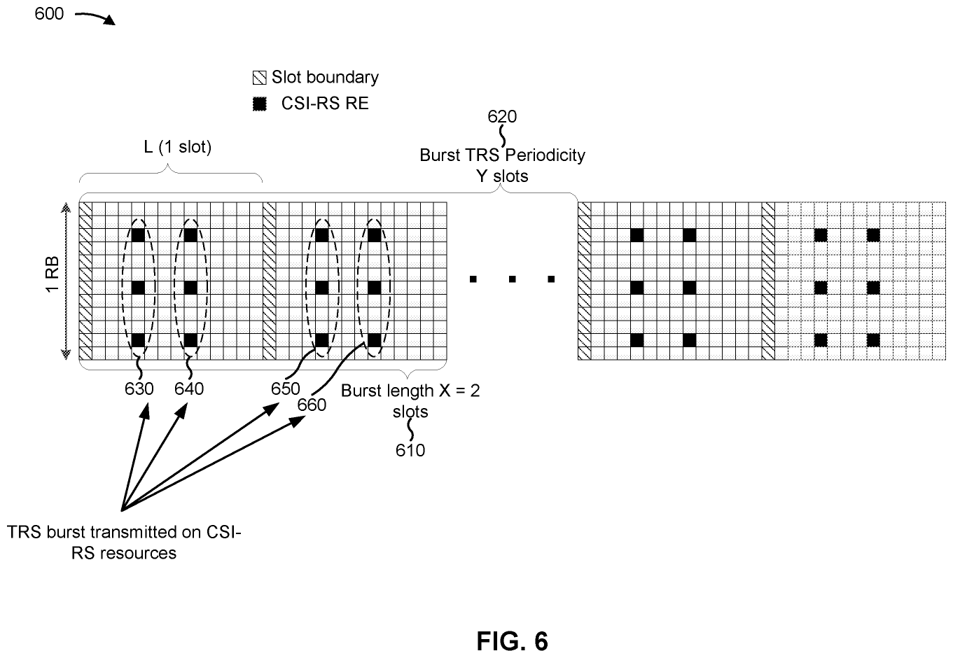

FIG. 6 is a diagram illustrating an example 600 of a TRS configuration, an accordance with the present disclosure. The TRS may be a CSI-RS for tracking that is configured using CSI-RS resources. The TRS may be transmitted in a burst 610 with a length of X slots (here, X=2), where the length of a slot is shown by L. CSI-RS resource elements (which may be used to transmit the TRS) are shown using a black fill, and slot boundaries of the slots are shown with a diagonal fill. As shown, the burst may have a TRS periodicity 620 of Y slots (Y being an integer number). For example, the burst periodicity of Y slots may correspond to a periodicity of 10 milliseconds (ms), 20 ms, 40 ms, or 80 ms. The TRS configuration may be configured as a non-zero power (NZP) CSI-RS resource set having multiple NZP CSI-RS resources. For example, as shown in FIG. 6, the set of CSI-RS resources configured for the TRS burst includes four CSI-RS resources 630, 640, 650, 660 configured in four symbols of two consecutive slots (e.g., with two CSI-RS resources in each slot). In some examples, each CSI-RS resource may include three resource elements (REs) per resource block (RB), and the REs may be spaced by a TRS subcarrier distance of four subcarriers. In some examples, an inter symbol distance between two CSI-RS resources in a slot may be 4 OFDM symbols.

In some examples, a TRS may not be linked to a CSI report to be transmitted by the UE. For example, in a current specification for a 3GPP wireless communication standard, a periodic or semi-persistent TRS may not be linked with a CSI report, and an aperiodic TRS must be linked with a CSI report configuration the indicates that no CSI report is to be transmitted (e.g., a CSI report configuration with reportQuantity=none).

As indicated above, FIG. 6 is provided as an example. Other examples may differ from what is described with regard to FIG. 6.

As described above in connection with FIG. 5, in some aspects, Doppler frequency measurements based on a TRS may be used by a network entity for downlink channel and/or precoder prediction for enhanced reciprocity-based downlink precoding and/or enhanced codebook-based downlink precoding. However, in some examples, such as in the current specification for the 3GPP wireless communication standard, a TRS may not be linked with a CSI report to be transmitted by the UE. Thus, the UE may not be able to report, to a network entity, Doppler frequency measurements performed on a TRS, and the network entity may not be able to predict the downlink channel and/or precoder at a future slot.

Some techniques and apparatuses described herein enable a UE to report, to a network entity, per path (or per path-group) Doppler frequency measurements performed on a TRS. In some aspects, the UE receive, from the network entity, a Doppler measurement report configuration. The UE may receive, from the network entity, a TRS. The UE may transmit, to the network entity, a Doppler measurement report in accordance with the Doppler measurement report configuration. The Doppler measurement report may indicate per path or per path-group Doppler frequency and Doppler frequency power measurements performed on the TRS, for one or more paths or path-groups. As a result, the network entity may be able to predict a downlink channel and/or downlink precoder for enhanced downlink precoding, which may result in improved reliability of communications for UEs, such as high mobility UEs.

FIGS. 7A-7G are diagrams illustrating an example 700 associated with per path Doppler reporting based on a TRS, in accordance with the present disclosure. As shown in FIG. 7A, example 700 includes communication between a network entity 701 (e.g., base station 110, CU 310, DU 330, RU 340, or a combination thereof) and a UE 120. In some aspects, the network entity 701 and the UE 120 may be included in a wireless network, such as wireless network 100. The network entity 701 and the UE 120 may communicate via a wireless access link, which may include an uplink and a downlink.

As shown in FIG. 7A, and by reference number 702, the network entity 701 may transmit, to the UE 120, a Doppler measurement report configuration. The UE 120 may receive the Doppler measurement report configuration transmitted by the network entity 701. For example, the network entity 701 may transmit the Doppler measurement report configuration to the UE 120 in an RRC message. The Doppler measurement report configuration may indicate a configuration of a Doppler measurement report for reporting TRS-based Doppler measurements to network entity 701.

In some aspects, the network entity 701 may also transmit, to the UE 120, a configuration for a TRS (e.g., a CSI-RS for tracking), and the Doppler measurement report configuration may be linked with the configuration for the TRS. For example, the Doppler measurement report configuration may be a CSI report configuration associated with the CSI-RS for tracking (e.g., the TRS). In some aspects, the CSI report configuration may be linked to a CSI-RS setting resourcesForChannelMeasurement that indicates the TRS (e.g., NZP CSI-RS sets for tracking). In this case, a new report quantity choice (e.g., PerPath-Doppler or PerPath-Doppler and Power or PerBeam-PerPath-Doppler) corresponding to the Doppler measurement report configuration may be added to the CSI report configuration (e.g., in addition to the choices for PMI, CQI, CRI, and LI).

In some aspects, the Doppler measurement report configuration may indicate a Doppler measurement configuration, a Doppler frequency configuration, and a Doppler power configuration. In some aspects, the Doppler measurement configuration may include configuration information that configures a plurality of paths (or path-groups) for the Doppler measurements to be performed by the UE 120 on the TRS and configures reporting path (or path-group) indexes for one or more paths (or path-group) of the plurality of paths (or path-groups) in the Doppler measurement report. In some aspects, the Doppler frequency configuration may include configuration information that configures a Doppler frequency quantization for reporting per-path (or path-group) Doppler frequency measurements in the Doppler measurement report and configures a number of Doppler frequency measurements to be reported per path (or path-group). In some aspects, the Doppler power configuration may configure reporting of per-path (or path-group) Doppler frequency power measurements in the Doppler measurement report. The configuration information included in the Doppler measurement report configuration is described in greater detail in connection with FIGS. 7B-7G.

As further shown in FIG. 7A, and by reference number 704, the network entity 701 may transmit, to the UE 120, the TRS. The UE 120 may receive the TRS transmitted by the network entity 701. For example, the TRS may be a CSI-RS for tracking. The network entity 701 may transmit the TRS in the CSI-RS resources configured for the TRS. In some aspects, the TRS may be a two-slot TRS transmitted in four CSI-RS resources in two consecutive slots. In some aspects (e.g., in FR2), the TRS may be a one-slot TRS transmitted in two CSI-RS resources in one slot.

In some aspects, the UE 120 may perform measurements on the TRS. In some aspects, the UE 120 may perform Doppler measurements on the TRS for a plurality of paths (or path-groups) configured by the Doppler measurement report configuration. For example, the UE 120 may perform Doppler frequency measurements and Doppler frequency power measurements on each path (or path-group) of the plurality of paths (or path-groups) configured by the Doppler measurement report configuration.

As further shown in FIG. 7A, and by reference number 706, in connection with receiving the TRS, the UE 120 may transmit, to the network entity 701, a Doppler measurement report in accordance with the Doppler measurement report configuration. The network entity 701 may receive the Doppler measurement report transmitted by the UE 120. The Doppler measurement report may indicate per path (or per path-group) Doppler measurements performed on the TRS, for one or more paths (or path-groups) of a plurality of paths configured by the Doppler measurement report configuration.

In some aspects, the Doppler measurement report may indicate per path Doppler measurements, for one or more paths of a plurality of paths configuration by the Doppler measurement report configuration. In some aspects, the Doppler measurement report may indicate per path-group Doppler measurements for one or more path-groups configured by the Doppler measurement report configuration. In this case, each path-group of the plurality of path-groups may be a cluster of paths, with a cluster resolution (e.g., a number of paths in each path-group) that may be configured by the Doppler measurement report configuration. In some aspects, the Doppler measurement report may indicate, for each path (or path-group) of the one or more paths (or path-groups), a time index associated with the path (or path-group), one or more Doppler frequency measurements for the path (or path-group), and one or more Doppler frequency power measurements for the path (or path-group). The Doppler measurement report is described in greater detail in connection with FIGS. 7B-7G.

As further shown in FIG. 7A, and by reference number 708, the network entity 701 may determine one or more transmission parameters for a downlink communication to the UE 120 based at least in part on the per path (or per path-group) Doppler measurements (e.g., per path or per path-group Doppler frequency measurements and Doppler frequency power measurements) indicated in the Doppler measurement report. In some aspects, the network entity 701 may determine one or more transmission parameters for a downlink communication in a future slot based at least in part on the per path (or per path-group) Doppler measurements. For example, the one or more transmission parameters may include a downlink precoder, number of layers and an MCS, or a CQI.

In some aspects, the network entity 701 may predict the downlink channel at a future slot based on an estimated channel (e.g., from an SRS) at a current slot and based at least in part on the per path (or per path-group Doppler measurements), for example as described above in connection with FIG. 5. The network entity 701 may then determine a downlink precoder (or one or more other transmission parameters) for a downlink communication in the future slot based at least in part on the predicted downlink channel at the future slot.

In some aspects, the network entity 701 predict a downlink precoder (and/or one or more other transmission parameters) for a downlink communication in a future slot based at least in part on the downlink precoder (and/or one or more other transmission parameters) selected in connection with an estimated downlink channel in a current slot (e.g., a downlink precoder indicated in a CSI-report received from the UE 120) and based at least in part on the per path (or per path-group) Doppler measurements, as described above in connection with FIG. 5.

As further shown in FIG. 7A, and by reference number 710, the network entity 701 may transmit a downlink communication (e.g., a PDSCH communication) to the UE 120 using the one or more transmission parameters determined, by the network entity 701, based at least in part on the per path (or per path-group) Doppler measurements indicated in the Doppler measurement report. The UE 120 may receive the downlink communication transmitted by the UE 120.

As shown in FIG. 7B, and by reference number 712, the Doppler measurement report configuration may configure a time window associated with the TRS, and the UE 120 may perform the Doppler frequency and Doppler frequency power measurements on the TRS for a plurality of paths (e.g., path 0-path 12 in FIG. 7B) within the time window. In some aspects, a maximum length of the time window may be based at least in part on the TRS configurations. For example, the maximum length of the time window may be

$$\frac{1}{4 Δ F}$$

seconds, where ΔF is the subcarrier spacing of the TRS. In some aspects, as shown by reference number 714, a time resolution of each path may be based at least in part on a bandwidth of the TRS. For example, the time resolution of each path may be

$$Tc = \frac{1}{{BW}_{TRS}} .$$

The time resolution Tc of one path may be referred to a one “tic.”

As further shown in FIG. 7B, and by reference number 716, the Doppler measurement report configuration may configure a plurality of path-groups with the time window. A path-group may be a group or cluster of paths for which the UE 120 may jointly measure and filter the Doppler frequencies with the paths/taps of that path-group, and the paths/taps in a path-group may be correlated and have similar Doppler profiles. The cluster resolution NT_{c} may indicate the number of paths in each path-group.

In some aspects, the Doppler measurement configuration (e.g., included in the Doppler measurement report configuration) may indicate a start of the time window and a length of the time window. For example, the Doppler measurement configuration may indicate the start of the time window with respect to a downlink reference time associated with the TRS in units of the TRS time resolution Tc (e.g., the time resolution of each path/tap). In some aspects, if a configured value for the start of the time window is not explicitly indicated in the Doppler measurement report configuration, the start of the time window may be the downlink reference time associated with the TRS. The Doppler measurement configuration may indicate the length of the window in absolute time (e.g., nanoseconds (ns)) or in a multiple of “tics” of the TRS time resolution Tc. In some aspects, if a configured value for the length of the window is not explicitly indicated in the Doppler measurement report configuration, the length of the window may be the maximum window length associated with the span of the TRS (e.g.,

$$\frac{1}{4 Δ F}$$

seconds). In some aspects, the Doppler measurement configuration may indicate the cluster resolution NT_{c} (e.g., the number of paths clustered in each path-group). In some aspects, if a configured value for cluster resolution NT_{c} is not explicitly indicated in the Doppler measurement report configuration, the absence of the configured value for the cluster resolution may provide an implicit indication to use a default value for the cluster resolution. For example, the default value for the cluster resolution may be NT_{c}=1, which corresponds to one path per path-group (e.g., per path Doppler measurements and reporting).

In some aspects, the Doppler measurement configuration may indicate a maximum number (X) of paths (or path-groups) for which the UE 120 is to report the Doppler frequency and Doppler frequency power measurements in the Doppler measurement report. In some aspects, if an explicit configured value for the maximum number of paths (or path-groups) is not included in the Doppler measurement report configuration, a default value (e.g., X=1) may be used as the maximum number of paths or path-groups for which the UE 120 is to report the Doppler frequency and Doppler frequency power measurements. In some aspects, the Doppler measurement configuration may indicate a threshold for identifying the paths (or path-groups) for which the Doppler frequency and Doppler power measurements are to be reported in the Doppler measurement report. In some aspects, the threshold may be a power threshold. In some aspects, the threshold may be a Doppler frequency threshold.

As shown in FIG. 7C, reference number 718 shows an example configuration with a window length=12*Tc, a window start at 2Tc, X=4, and NT_{c}=1 (e.g., per-path Doppler measurements and reporting). In some aspects, the UE 120 may report the Doppler measurements for up to X strongest paths above the threshold (e.g., with a measured power above the power threshold or with a measured Doppler frequency above the Doppler frequency threshold). As shown by reference number 720, FIG. 7C shows an example of fields in the Doppler measurement report for path (or path-group) index reporting. As shown by reference number 722, the Doppler measurement report may include an indication of a number (Nₚ) of paths for which per path (or per path-group) Doppler measurements are indicated in the Doppler measurement report, where Np≤X, and the indication of Nₚ in the Doppler measurement report has a bit-width of log₂ (X). In the example shown by reference number 718 in FIG. 7C, there are three paths (e.g., path 1, path 5, and path 7) with measurements (e.g., power measurements or Doppler frequency measurements) above the threshold, and the Doppler measurement report may an indication of Nₚ=3. As shown by reference number 724, the Doppler measurement report may include an indication of the path indexes (or path-group indexes) of the Nₚ paths for which the per path (or per path-group) Doppler measurements are reported, and the indication of the path (or path-group) indexes (e.g., Path index #1, #2, . . . , #Nₚ) may have a bit-width of

$$⌈ {log}_{2} ( \begin{matrix}{N}_{T} \\ {N}_{P}\end{matrix} ) ⌉ ,$$

where N_{T} is the total number of paths (or path-groups) in the time window. In the example shown by reference number 718 in FIG. 7C, the Doppler measurement report may include an indication of index #1, index #5, and index #7. The path (or path-group) indexes may be the time indexes for the paths (or path-groups) in the time window. As shown by reference number 726, the Doppler measurement report may include an indication of a strongest path index (or path-group index), with a bit-width of log₂ N_{T}. The strongest path index may be the index of the strongest path (e.g., with a highest measured power) among the paths in the time window (e.g., or among the Nₚ paths for which Doppler measurement are reported). The strongest path index may be used to align timing between the UE 120 and the network entity 701. In the example shown by reference number 718 in FIG. 7C, the Doppler measurement report may include an indication of index #5 for the strongest path index.

In some aspects, the Doppler frequency configuration (e.g., included in the Doppler measurement report configuration) may indicate a maximum number (N_{d}) of frequency values to report for each path (or path-group) of the one or more (e.g., Nₚ) paths (or path-groups) for which per-path (or per path-group) Doppler frequency measurements are reported. For example, N_{fd}=1 indicates that the UE 120 is to report a single Doppler frequency value per path (or path-group), and N_{fd}>1 indicates that the UE 120 is to report multiple measured Doppler frequency values per path (or path-group). In some aspects, the default value of N_{fd} is 1 if it is configured to the UE.

As shown in FIG. 7D, and by reference number 728, the Doppler frequency configuration may indicate a Doppler frequency quantization for reporting the per path (or per path-group) Doppler frequency measurements in the Doppler measurement report. In some aspects, the Doppler frequency configuration may indicate a maximum Doppler frequency (F_{d,max}) and a minimum Doppler frequency (F_{d,min}) for the Doppler frequency quantization, which configure a Doppler frequency range for Doppler frequency quantization. In some examples, the Doppler frequency range may be symmetric (e.g., F_{d,max} and F_{d,min} may be related). In some examples the Doppler frequency range may be asymmetric (e.g., F_{d,max} and F_{d,min} may not be related). In some aspects, the Doppler frequency quantization may include a plurality of Doppler frequency bins, and the Doppler frequency configuration may indicate a bin resolution (or multiple bin resolutions) for the Doppler frequency bins of the Doppler frequency quantization. The Doppler frequency quantization may be a uniform quantization or a non-uniform quantization. In a uniform quantization, all of the Doppler frequency bins have the same bin resolution. Reference number 730 shows an example of a uniform quantization with F_{d,max}=750 Hz, F_{d,min}=−750 Hz, and a bin resolution of 250 Hz. In a non-uniform quantization, the bin resolution may be non-uniform (e.g., not all bins have the same bin resolution). Reference number 732 shows an example of a non-uniform quantization with F_{d,max}=750 Hz, F_{d,min}=−750 Hz, and bin resolutions of 150 Hz and 450 Hz.

In some aspects, the Doppler frequency bins of the Doppler frequency quantization may be associated with respective codes (e.g., bit values) for the UE 120 to use to indicate Doppler frequency values in the Doppler frequency bins. As shown in FIG. 7D, table 734 shows coded Doppler frequency bins for the example uniform Doppler frequency quantization shown by reference number 730 and the example non-uniform Doppler frequency shown by reference number 732. In some aspects, the Doppler frequency configuration may indicate a scaling factor (a) for scaling the Doppler frequency quantization. The scaling factor (a) may be applied to scale the Doppler frequency range (e.g., the maximum Doppler frequency and the minimum Doppler frequency) and the bin resolution of the Doppler frequency quantization. For example, the uniform quantization and the non-uniform quantization shown in Table 734 may be associated with a scaling factor of α=1. For a scaling factor of α=2, the uniform quantization may be scaled to a Doppler frequency range from −1500 Hz to 1500 Hz with a resolution of 500 Hz. In some aspects, the Doppler frequency quantization may be signal-to-noise-ratio (SNR) dependent.

As shown by reference number 736, FIG. 7E shows an example of fields in the Doppler measurement report for Doppler frequency reporting. As shown by reference number 738, the Doppler measurement report may include, for each path (or path-group) of the Nₚ paths (or path-groups), a respective indication of a number (Z) of reported Doppler frequency values for that per path (or per path-group), where Z≤N_{fd}, and the indication of Z in the Doppler measurement report has a bit-width of log₂ (N_{fd}). As shown by reference number 740, the Doppler measurement report may include, for each path (or path-group) of the Nₚ paths (or path-groups), an indication of the Z Doppler frequency values for that path (or path-group). The Z Doppler frequency values may be indicated in the Doppler measurement report in accordance with the Doppler frequency quantization. For example, the Z Doppler frequency values may be indicated using codes (e.g., bit values) associated with corresponding Doppler frequency bins (e.g., bin #1, bin #2, . . . , bin #Z) of the Doppler frequency quantization. In this case, the indication of the Z Doppler frequency values for a path (or path-group) may have a bit-width of Z*Nbit_Doppler, where Nbit_Doppler is the number of bits used for the codes that identify the Doppler frequency bins.

In some aspects, the UE 120 may report the actual Doppler frequency measurements (F_{d}) (e.g., the UE 120 may indicate the Doppler frequency bins for the actual Doppler frequency measurements) for each path (or path-group). In some aspects, the UE 120 may report (e.g., by indicating Doppler frequency bins), for each Doppler frequency measurement (F_{d}), the differential Doppler frequency (F_{d}−F_{ref}) with respect to a reference Doppler frequency (F_{ref}). For example, the reference Doppler frequency (F_{ref}) may be the mean Doppler frequency with the largest value, among the mean Doppler frequencies for all of the Nₚ paths (or path-groups) for which Doppler frequency measurements are being reported. In some aspects, the UE 120 may report (e.g., by indicating Doppler frequency bins), for each Doppler frequency measurement (F_{d}), the relative Doppler frequency (F_{d}/abs(Fₘₐₓ)) in either the linear domain or dB domain, with respect to the reference Doppler frequency (F_{ref}). As shown by reference number 742, in some aspects (e.g., in cases in which the UE 120 reports the differential Doppler frequency or the relative Doppler frequency), the Doppler measurement report may include an indication of a reference Doppler path index (or path-group index), with a bit-width of log₂ N_{T}. The reference Doppler path index (or path-group index) may be the index of the path (or path-group) associated with the reference Doppler frequency (e.g., the path (or path-group) with the largest mean Doppler frequency value).

In some aspects, when the UE 120 is configured to report N_{fd} Doppler frequency values per path (or path-group) and the UE 120 measures fewer than N_{fd} Doppler frequency values for a path (or path-group), the UE 120 may report the actual measured number of Doppler frequencies per path (or path-group), and the UE 120 may indicate the number of measured Doppler frequencies per path (or path-group). In some aspects, when the UE 120 is configured to report N_{fd} Doppler frequency values per path (or path-group) and the UE 120 measures fewer than N_{fd} Doppler frequency values for a path (or path-group), the UE 120 may duplicate measured frequency values and report N_{fd} Doppler frequency values for each path (or path-group).

In some aspects, the Doppler power configuration (e.g., included in the Doppler measurement report configuration) may indicate a maximum number (Nₚ) of Doppler frequency power measurements to be reported per path (or per-path group). In some aspects, Nₚₒ=1, and the UE 120 may be configured to report the same Doppler frequency power across all Doppler frequency measurements for a path (or path-group). In some aspects, Nₚₒ=N_{fd}, and the UE 120 may be configured to report a respective Doppler frequency power measurement for each reported Doppler frequency measurement for each path (or path-group). As shown in FIG. 7F, the Doppler frequency power measurements may represent as respective power coefficients p for N_{fd} Doppler frequency measurements, for each of Nₚ paths (or path-groups). As shown by reference number 744, the UE 120 may determine the strongest power coefficient (e.g., the strongest Doppler frequency power measurement) across all Doppler frequency measurement and across all paths (or path-groups), and the UE 120 may report the index of the strongest power coefficient (e.g., the strongest Doppler frequency power measurement) in the Doppler measurement report. There may be no need to quantize this strongest Doppler frequency power measurement, and the UE 120 may use this strongest Doppler frequency power measurement as a reference for quantizing the remaining Doppler frequency power measurements. As shown by reference number 746, the UE 120 may quantize the remaining power coefficients (e.g., the remaining Doppler frequency power measurements) with a power differential or a power ratio, with respect to the strongest power coefficient. In some aspects, for each remaining power coefficient, the UE 120 may determine a differential between the amplitude of that power coefficient and the amplitude of the strongest power coefficient, and the UE 120 may quantize that power coefficient with N-bits from 0 dB with a −X dB (in power) step size.

FIG. 7G shows an example information included in the Doppler measurement report. As shown reference number 750, the Doppler measurement report may include an indication of the number (Nₚ) of paths for which per path (or per path-group) Doppler measurements are indicated in the Doppler measurement report, with a bit-width of log₂ (X). As shown by reference number 752, the Doppler measurement report may include an indication of the path indexes (or path-group indexes) (e.g., Path index #1, #2, . . . , #Nₚ) of the Nₚ paths for which the per path (or per path-group) Doppler measurements are reported, with a bit-width of

$$⌈ {log}_{2} ( \begin{matrix}{N}_{T} \\ {N}_{P}\end{matrix} ) ⌉ .$$

As shown by reference number 754, the Doppler measurement report may include an indication of a strongest path index (or path-group index), with a bit-width of log₂ N_{T}. As shown by reference number 756, the Doppler measurement report may include, for each path (or path-group) of the Nₚ paths (or path-groups), a respective indication of a number (Z) of reported Doppler frequency values for that per path (or per path-group), with a bit-width of log₂ (N_{fd}). As shown by reference number 758, the Doppler measurement report may include Doppler frequency values (e.g., bin #1, bin #2, . . . , bin #Z) for each path (or path-group) of the Nₚ paths (or path-groups), with a bit-width of Z*Nbit_Doppler*Nₚ. As shown by reference number 760, the Doppler measurement report may include an indication of a reference Doppler path index (or path-group index), with a bit-width of log₂ ZNₚ. As shown by reference number 762, the Doppler measurement report may include an indication of Doppler frequency powers (e.g., #1, #2, . . . #Z) for each path (or path-group) of the Nₚ paths (or path-groups), with a bit-width of Z*Nbit_Doppler*Nₚ. As shown by reference number 764, the Doppler measurement report may include an indication of the strongest Doppler spectrum power indication (e.g., an index of the strongest Doppler frequency power measurement), with a bit-width of log₂ ZNₚ.

The UE 120 may transmit the Doppler measurement report to the network entity 701 in an uplink channel (e.g., PUSCH or PUCCH). In some aspects, the Doppler measurement report may be included in UCI. For example, the Doppler measurement report may be included in UCI part 2 or UCI part 3 of a CSI report.

As indicated above, FIG. 7 is provided as an example. Other examples may differ from what is described with respect to FIG. 7.

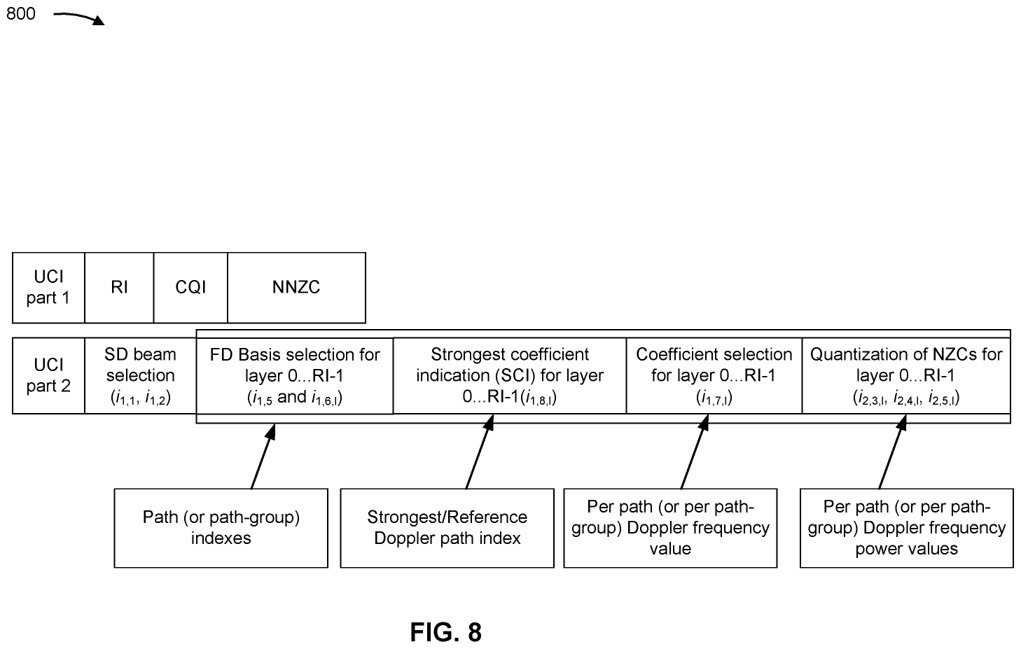

FIG. 8 is a diagram illustrating an example 800 associated with per path Doppler reporting based on a TRS, in accordance with the present disclosure. As shown in FIG. 8, in some aspects, a UE (e.g., UE 120) may transmit, to a network entity (e.g., network entity 701) a Doppler measurement report, which indicates per path (or per path-group) Doppler frequency and Doppler frequency power measurements, in a UCI part 2 of an e-Type II CSI reporting structure. In an e-Type II CSI reporting structure, precoders for a layer l across N₃ (≤19) PMI subbands are given by size-Nₜ×N₃ matrix W^{(l)}=W₁\tilde{W}_{2,l}W_{f,l}^{H}, with spatial domain (SD) basis W₁ (discrete Fourier transform (DFT) bases), frequency domain (FD) basis W_{f,l}^{H} (DFT bases), and coefficients \tilde{W}_{2,l}. In some aspects, the UCI part 2 for the FD basis and the coefficients can be leveraged for per path (or per path-group) Doppler shift reporting. As shown in FIG. 8, the FD basis portion of the UCI part 2 may be used for path (or path-group) index reporting. The coefficient selection portion of the UCI part 2 may be used for reporting Doppler frequency values for each path (or path-group) (e.g., per path instead of per layer). The non-zero coefficient (NZC) portion of the UCI part 2 may be used for reporting the Doppler frequency power measurements (e.g., per path instead of per layer). The strongest coefficient indication portion of the UCI part 2 may be used for reporting the strongest path index and/or the reference Doppler path index. In some aspects, transmission of the Doppler measurement report using the UCI part 2 in the e-Type II CSI reporting structure may enable multiplexing Type 1 (RI, CQI, PMI) with the Doppler measurement report in same CSI reporting. As shown in FIG. 8, the UCI part 1 may indicate the RI, the CQI, and a number of non-zero coefficients (NNZC).

As indicated above, FIG. 8 is provided as an example. Other examples may differ from what is described with respect to FIG. 8.

FIG. 9 is a diagram illustrating an example process 900 performed, for example, by a UE, in accordance with the present disclosure. Example process 900 is an example where the UE (e.g., UE 120) performs operations associated with per path Doppler reporting based on a TRS.

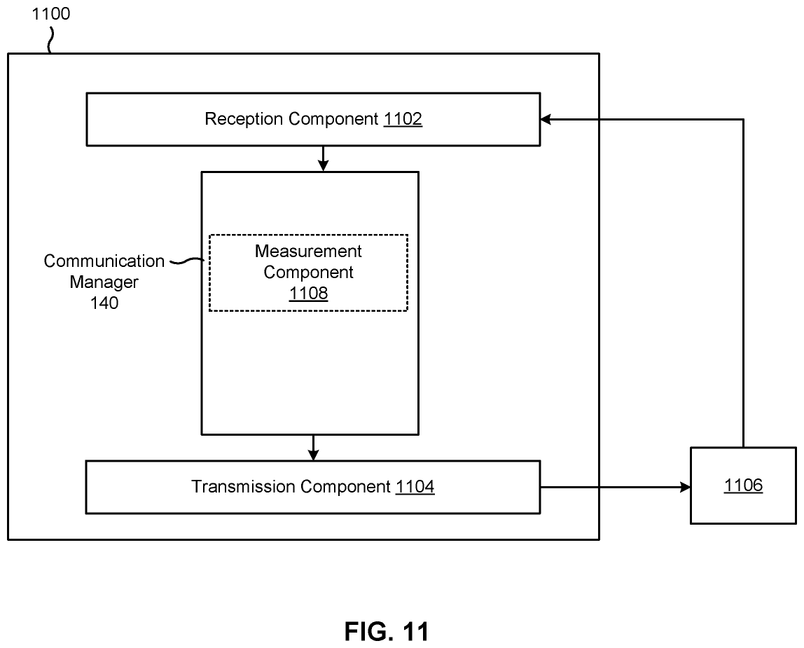

As shown in FIG. 9, in some aspects, process 900 may include receiving, from a network entity, a Doppler measurement report configuration (block 910). For example, the UE (e.g., using communication manager 140 and/or reception component 1102, depicted in FIG. 11) may receive, from a network entity, a Doppler measurement report configuration, as described above.

As further shown in FIG. 9, in some aspects, process 900 may include receiving, from the network entity, a TRS (block 920). For example, the UE (e.g., using communication manager 140 and/or reception component 1102, depicted in FIG. 11) may receive, from the network entity, a TRS, as described above.

As further shown in FIG. 9, in some aspects, process 900 may include transmitting, to the network entity, a Doppler measurement report in accordance with the Doppler measurement report configuration, wherein the Doppler measurement report indicates per path or per path-group Doppler frequency and Doppler frequency power measurements performed on the TRS, for one or more paths or path-groups (block 930). For example, the UE (e.g., using communication manager 140 and/or transmission component 1104, depicted in FIG. 11) may transmit, to the network entity, a Doppler measurement report in accordance with the Doppler measurement report configuration, wherein the Doppler measurement report indicates per path or per path-group Doppler frequency and Doppler frequency power measurements performed on the TRS, for one or more paths or path-groups, as described above.

Process 900 may include additional aspects, such as any single aspect or any combination of aspects described below and/or in connection with one or more other processes described elsewhere herein.

In a first aspect, the TRS is a CSI-RS for tracking, the Doppler measurement report configuration is a CSI report configuration, and the Doppler measurement report is a CSI report.

In a second aspect, the Doppler measurement report indicates, for each path or path-group of the one or more paths or path-groups, a time index associated with the path or path-group, one or more Doppler frequency measurements for the path or path-group, and one or more Doppler frequency power measurements for the path or path group.

In a third aspect, the one or more paths or path-groups, for which the per path or per path-group Doppler frequency and Doppler frequency power measurements are indicated in the Doppler measurement report, are included in a plurality of paths within a time window associated with the TRS, and wherein a resolution of each path of the plurality of paths is based at least in part on a bandwidth of the TRS.

In a fourth aspect, the Doppler measurement report configuration indicates a start of the time window with respect to a downlink reference time associated with the TRS and a length of the time window.

In a fifth aspect, the Doppler measurement report configuration indicates a cluster resolution for clustering the plurality of paths into path-groups.

In a sixth aspect, the Doppler measurement report configuration includes a configured value for the cluster resolution, or wherein the Doppler measurement report configuration indicates, by absence of the configured value for the cluster resolution, a default value for the cluster resolution.

In a seventh aspect, the Doppler measurement report configuration indicates a maximum number of the one or more paths or path-groups for which the per path or per path-group Doppler frequency and Doppler frequency measurements are indicated in the Doppler measurement report and a threshold for identifying the one or more paths or path-groups for which the per path or per path-group Doppler frequency and Doppler frequency power measurements are indicated in the Doppler measurement report.

In an eighth aspect, the threshold for identifying the one or more paths or path-groups is a power threshold.

In a ninth aspect, the threshold for identifying the one or more paths or path-groups is a Doppler frequency threshold.

In a tenth aspect, the Doppler measurement report includes a number of the one or more paths or path-groups for which the per path or per path-group Doppler frequency and Doppler frequency power measurements are indicated in the Doppler measurement report, indications of indexes for the one or more paths or path-groups, and an indication of an index for a strongest path or path-group of the one or more paths or path-groups.

In an eleventh aspect, the Doppler measurement report configuration indicates a Doppler frequency range and Doppler frequency quantization for reporting Doppler frequency measurements for the one or more paths or path-groups in the Doppler measurement report, and a number of Doppler frequency measurements to be reported in the Doppler measurement report for each path or path-group of the one or more paths or path-groups.

In a twelfth aspect, the Doppler frequency quantization is a uniform quantization with a plurality of Doppler frequency bins having a same bin resolution.

In a thirteenth aspect, the Doppler frequency quantization is a non-uniform quantization with a plurality of Doppler frequency bins with non-uniform bin resolutions.

In a fourteenth aspect, the Doppler measurement report configuration further indicates a scaling factor for scaling the Doppler frequency range and the Doppler frequency quantization.

In a fifteenth aspect, the Doppler measurement report indicates, for each path or path-group of the one or more paths or path-groups, one or more Doppler frequency measurements for the path or path-group in accordance with the Doppler frequency quantization.

In a sixteenth aspect, for each path or path-group of the one or more paths or path-groups, the Doppler measurement report indicates a measured Doppler frequency for each Doppler frequency measurement of the one or more Doppler frequency measurements for the path or path-group.

In a seventeenth aspect, the Doppler measurement report indicates an index of a path or path-group associated with a reference Doppler frequency, and wherein, for each path or path-group of the one or more paths or path-groups, the Doppler measurement report indicates a differential Doppler frequency with respect to the reference Doppler frequency for each Doppler frequency measurement of the one or more Doppler frequency measurements for the path or path-group.

In an eighteenth aspect, the Doppler measurement report indicates an index of a path or path-group associated with a reference Doppler frequency, and wherein, for each path or path-group of the one or more paths or path-groups, the Doppler measurement report indicates a relative Doppler frequency with respect to the reference Doppler frequency for each Doppler frequency measurement of the one or more Doppler frequency measurements for the path or path-group.

In a nineteenth aspect, the Doppler measurement report indicates, for each path or path-group of the one or more paths or path-groups, respective Doppler frequency bins of the Doppler frequency quantization for each of one or more Doppler frequency measurements for the path or path-group, a number of the one or more Doppler frequency measurements for the path or path-group, and an index for with a path or path-group associated with a reference Doppler frequency.

In a twentieth aspect, the Doppler measurement report indicates a respective Doppler frequency power measurement for each path or path-group of the one or more paths or path-groups.

In a twenty-first aspect, the Doppler measurement report indicates, for each path or path-group of the one or more paths or paths-groups, one or more Doppler frequency measurements for the path or path-group and a respective Doppler frequency power measurement for Doppler frequency measurement of the one or more Doppler frequency measurements for the path or path-group.

In a twenty-second aspect, the Doppler measurement report indicates an index for a path or path-group associated with a strongest Doppler frequency power measurement, among the one or more paths or path-groups, and wherein the Doppler measurement report indicates a respective power ratio or power differential, with respect to the strongest Doppler frequency power measurement, for each of one or more Doppler frequency power measurements for each path or path-group of the one or more paths or path-groups.

In a twenty-third aspect, the Doppler measurement report is included in UCI.

In a twenty-fourth aspect, the Doppler measurement report is included in UCI part 2 or UCI part 3 of a CSI report.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a network entity, in accordance with the present disclosure. Example process 1000 is an example where the network entity (e.g., network entity 701) performs operations associated with per path Doppler reporting based on a TRS.

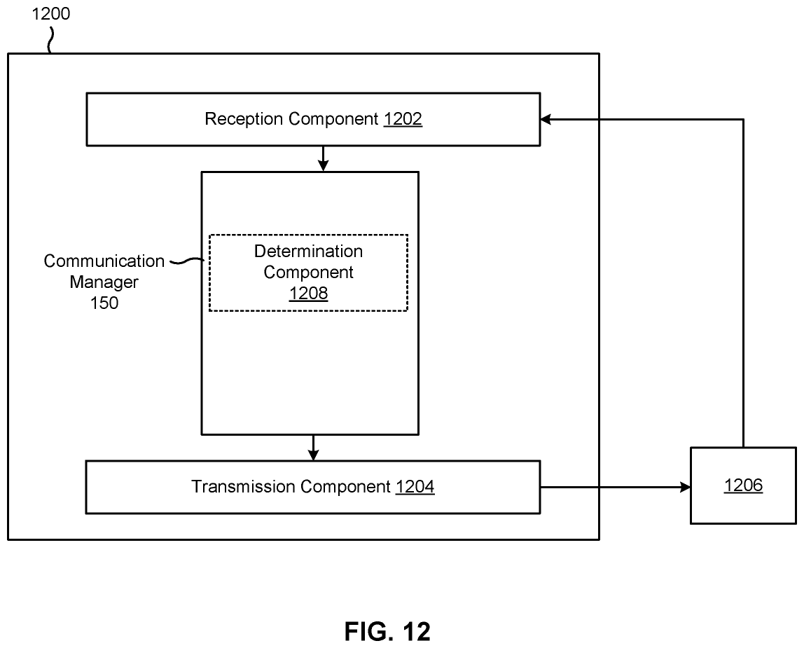

As shown in FIG. 10, in some aspects, process 1000 may include transmitting a Doppler measurement report configuration (block 1010). For example, the network entity (e.g., using communication manager 150 and/or transmission component 1204, depicted in FIG. 12) may transmit a Doppler measurement report configuration, as described above.

As further shown in FIG. 10, in some aspects, process 1000 may include transmitting a TRS (block 1020). For example, the network entity (e.g., using communication manager 150 and/or transmission component 1204, depicted in FIG. 12) may transmit a TRS, as described above.

As further shown in FIG. 10, in some aspects, process 1000 may include receiving a Doppler measurement report associated with a UE in accordance with the Doppler measurement report configuration, wherein the Doppler measurement report indicates per path or per path-group Doppler frequency and Doppler frequency power measurements performed on the TRS, for one or more paths or path-groups (block 1030). For example, the network entity (e.g., using communication manager 150 and/or reception component 1202, depicted in FIG. 12) may receive a Doppler measurement report associated with a UE in accordance with the Doppler measurement report configuration, wherein the Doppler measurement report indicates per path or per path-group Doppler frequency and Doppler frequency power measurements performed on the TRS, for one or more paths or path-groups, as described above.

Process 1000 may include additional aspects, such as any single aspect or any combination of aspects described below and/or in connection with one or more other processes described elsewhere herein.

In a first aspect, the TRS is a CSI-RS for tracking, the Doppler measurement report configuration is a CSI report configuration, and the Doppler measurement report is a CSI report.

In a second aspect, the Doppler measurement report indicates, for each path or path-group of the one or more paths or path-groups, a time index associated with the path or path-group, one or more Doppler frequency measurements for the path or path-group, and one or more Doppler frequency power measurements for the path or path group.

In a third aspect, the one or more paths or path-groups, for which the per path or per path-group Doppler frequency and Doppler frequency power measurements are indicated in the Doppler measurement report, are included in a plurality of paths within a time window associated with the TRS, and wherein a resolution of each path of the plurality of paths is based at least in part on a bandwidth of the TRS.

In a fourth aspect, the Doppler measurement report configuration indicates a start of the time window with respect to a downlink reference time associated with the TRS and a length of the time window.

In a fifth aspect, the Doppler measurement report configuration indicates a cluster resolution for clustering the plurality of paths into path-groups.

In a sixth aspect, the Doppler measurement report configuration includes a configured value for the cluster resolution, or wherein the Doppler measurement report configuration indicates, by absence of the configured value for the cluster resolution, a default value for the cluster resolution.

In a seventh aspect, the Doppler measurement report configuration indicates a maximum number of the one or more paths or path-groups for which the per path or per path-group Doppler frequency and Doppler frequency measurements are indicated in the Doppler measurement report and a threshold for identifying the one or more paths or path-groups for which the per path or per path-group Doppler frequency and Doppler frequency power measurements are indicated in the Doppler measurement report.

In an eighth aspect, the threshold for identifying the one or more paths or path-groups is a power threshold.

In a ninth aspect, the threshold for identifying the one or more paths or path-groups is a Doppler frequency threshold.

In a tenth aspect, the Doppler measurement report includes a number of the one or more paths or path-groups for which the per path or per path-group Doppler frequency and Doppler frequency power measurements are indicated in the Doppler measurement report, indications of indexes for the one or more paths or path-groups, and an indication of an index for a strongest path or path-group of the one or more paths or path-groups.

In an eleventh aspect, the Doppler measurement report configuration indicates a Doppler frequency range and Doppler frequency quantization for reporting Doppler frequency measurements for the one or more paths or path-groups in the Doppler measurement report, and a number of Doppler frequency measurements to be reported in the Doppler measurement report for each path or path-group of the one or more paths or path-groups.

In a twelfth aspect, the Doppler frequency quantization is a uniform quantization with a plurality of Doppler frequency bins having a same bin resolution.

In a thirteenth aspect, the Doppler frequency quantization is a non-uniform quantization with a plurality of Doppler frequency bins with non-uniform bin resolutions.

In a fourteenth aspect, the Doppler measurement report configuration further indicates a scaling factor for scaling the Doppler frequency range and the Doppler frequency quantization.

In a fifteenth aspect, the Doppler measurement report indicates, for each path or path-group of the one or more paths or path-groups, one or more Doppler frequency measurements for the path or path-group in accordance with the Doppler frequency quantization.

In a sixteenth aspect, for each path or path-group of the one or more paths or path-groups, the Doppler measurement report indicates a measured Doppler frequency for each Doppler frequency measurement of the one or more Doppler frequency measurements for the path or path-group.

In a seventeenth aspect, the Doppler measurement report indicates an index of a path or path-group associated with a reference Doppler frequency, and wherein, for each path or path-group of the one or more paths or path-groups, the Doppler measurement report indicates a differential Doppler frequency with respect to the reference Doppler frequency for each Doppler frequency measurement of the one or more Doppler frequency measurements for the path or path-group.

In an eighteenth aspect, the Doppler measurement report indicates an index of a path or path-group associated with a reference Doppler frequency, and wherein, for each path or path-group of the one or more paths or path-groups, the Doppler measurement report indicates a relative Doppler frequency with respect to the reference Doppler frequency for each Doppler frequency measurement of the one or more Doppler frequency measurements for the path or path-group.

In a nineteenth aspect, the Doppler measurement report indicates, for each path or path-group of the one or more paths or path-groups, respective Doppler frequency bins of the Doppler frequency quantization for each of one or more Doppler frequency measurements for the path or path-group, a number of the one or more Doppler frequency measurements for the path or path-group, and an index for with a path or path-group associated with a reference Doppler frequency.

In a twentieth aspect, the Doppler measurement report indicates a respective Doppler frequency power measurement for each path or path-group of the one or more paths or path-groups.

In a twenty-first aspect, the Doppler measurement report indicates, for each path or path-group of the one or more paths or paths-groups, one or more Doppler frequency measurements for the path or path-group and a respective Doppler frequency power measurement for Doppler frequency measurement of the one or more Doppler frequency measurements for the path or path-group.

In a twenty-second aspect, the Doppler measurement report indicates an index for a path or path-group associated with a strongest Doppler frequency power measurement, among the one or more paths or path-groups, and wherein the Doppler measurement report indicates a respective power ratio or power differential, with respect to the strongest Doppler frequency power measurement, for each of one or more Doppler frequency power measurements for each path or path-group of the one or more paths or path-groups.

In a twenty-third aspect, the Doppler measurement report is included in UCI.

In a twenty-fourth aspect, the Doppler measurement report is included in UCI part 2 or UCI part 3 of a CSI report.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication. The apparatus 1100 may be a UE, or a UE may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 140. The communication manager 140 may include a measurement component 1108, among other examples.

In some aspects, the apparatus 1100 may be configured to perform one or more operations described herein in connection with FIGS. 7A-7G and 8. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the UE described in connection with FIG. 2. In some aspects, the transmission component 1104 may be co-located with the reception component 1102 in a transceiver.

The reception component 1102 may receive, from a network entity, a Doppler measurement report configuration. The reception component 1102 may receive, from the network entity, a TRS. The transmission component 1104 may transmit, to the network entity, a Doppler measurement report in accordance with the Doppler measurement report configuration, wherein the Doppler measurement report indicates per path or per path-group Doppler frequency and Doppler frequency power measurements performed on the TRS, for one or more paths or path-groups. The measurement component 1108 may perform the Doppler frequency and Doppler frequency power measurements on the TRS.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication. The apparatus 1200 may be a network entity, or a network entity may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 150. The communication manager 150 may include a determination component 1208, among other examples.

In some aspects, the apparatus 1200 may be configured to perform one or more operations described herein in connection with FIGS. 7A-7G and 8. Additionally, or alternatively, the apparatus 1200 may be configured to perform one or more processes described herein, such as process 1000 of FIG. 10, or a combination thereof. In some aspects, the apparatus 1200 and/or one or more components shown in FIG. 12 may include one or more components of the network entity described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the network entity described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the network entity described in connection with FIG. 2. In some aspects, the transmission component 1204 may be co-located with the reception component 1202 in a transceiver.

The transmission component 1204 may transmit a Doppler measurement report configuration. The transmission component 1204 may transmit a TRS. The reception component 1202 may receive a Doppler measurement report associated with a UE in accordance with the Doppler measurement report configuration, wherein the Doppler measurement report indicates per path or per path-group Doppler frequency and Doppler frequency power measurements performed on the TRS, for one or more paths or path-groups. The determination component 1208 may determine the Doppler measurement report configuration.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:
Aspect 1: A method of wireless communication performed by a user equipment (UE), comprising: receiving, from a network entity, a Doppler measurement report configuration; receiving, from the network entity, a tracking reference signal (TRS); and transmitting, to the network entity, a Doppler measurement report in accordance with the Doppler measurement report configuration, wherein the Doppler measurement report indicates per path or per path-group Doppler frequency and Doppler frequency power measurements performed on the TRS, for one or more paths or path-groups.
Aspect 2: The method of Aspect 1, wherein the TRS is a channel state information (CSI) reference signal (CSI-RS) for tracking, the Doppler measurement report configuration is a CSI report configuration, and the Doppler measurement report is a CSI report.
Aspect 3: The method of any of Aspects 1-2, wherein the Doppler measurement report indicates, for each path or path-group of the one or more paths or path-groups, a time index associated with the path or path-group, one or more Doppler frequency measurements for the path or path-group, and one or more Doppler frequency power measurements for the path or path group.
Aspect 4: The method of any of Aspects 1-3, wherein the one or more paths or path-groups, for which the per path or per path-group Doppler frequency and Doppler frequency power measurements are indicated in the Doppler measurement report, are included in a plurality of paths within a time window associated with the TRS, and wherein a resolution of each path of the plurality of paths is based at least in part on a bandwidth of the TRS.
Aspect 5: The method of Aspect 4, wherein the Doppler measurement report configuration indicates a start of the time window with respect to a downlink reference time associated with the TRS and a length of the time window.
Aspect 6: The method of any of Aspects 4-5, wherein the Doppler measurement report configuration indicates a cluster resolution for clustering the plurality of paths into path-groups.
Aspect 7: The method of Aspect 6, wherein the Doppler measurement report configuration includes a configured value for the cluster resolution, or wherein the Doppler measurement report configuration indicates, by absence of the configured value for the cluster resolution, a default value for the cluster resolution.
Aspect 8: The method of any of Aspects 4-7, wherein the Doppler measurement report configuration indicates a maximum number of the one or more paths or path-groups for which the per path or per path-group Doppler frequency and Doppler frequency measurements are indicated in the Doppler measurement report and a threshold for identifying the one or more paths or path-groups for which the per path or per path-group Doppler frequency and Doppler frequency power measurements are indicated in the Doppler measurement report.
Aspect 9: The method of Aspect 8, wherein the threshold for identifying the one or more paths or path-groups is a power threshold.
Aspect 10: The method of Aspect 8, wherein the threshold for identifying the one or more paths or path-groups is a Doppler frequency threshold.
Aspect 11: The method of any of Aspects 8-10, wherein the Doppler measurement report includes a number of the one or more paths or path-groups for which the per path or per path-group Doppler frequency and Doppler frequency power measurements are indicated in the Doppler measurement report, indications of indexes for the one or more paths or path-groups, and an indication of an index for a strongest path or path-group of the one or more paths or path-groups.
Aspect 12: The method of any of Aspects 1-11, wherein the Doppler measurement report configuration indicates a Doppler frequency range and Doppler frequency quantization for reporting Doppler frequency measurements for the one or more paths or path-groups in the Doppler measurement report, and a number of Doppler frequency measurements to be reported in the Doppler measurement report for each path or path-group of the one or more paths or path-groups.
Aspect 13: The method of Aspect 12, wherein the Doppler frequency quantization is a uniform quantization with a plurality of Doppler frequency bins having a same bin resolution.
Aspect 14: The method of Aspect 12, wherein the Doppler frequency quantization is a non-uniform quantization with a plurality of Doppler frequency bins with non-uniform bin resolutions.
Aspect 15: The method of any of Aspects 12-14, wherein the Doppler measurement report configuration further indicates a scaling factor for scaling the Doppler frequency range and the Doppler frequency quantization.
Aspect 16: The method of any of Aspects 12-15, wherein the Doppler measurement report indicates, for each path or path-group of the one or more paths or path-groups, one or more Doppler frequency measurements for the path or path-group in accordance with the Doppler frequency quantization.
Aspect 17: The method of Aspect 16, wherein for each path or path-group of the one or more paths or path-groups, the Doppler measurement report indicates a measured Doppler frequency for each Doppler frequency measurement of the one or more Doppler frequency measurements for the path or path-group.
Aspect 18: The method of Aspect 16, wherein the Doppler measurement report indicates an index of a path or path-group associated with a reference Doppler frequency, and wherein, for each path or path-group of the one or more paths or path-groups, the Doppler measurement report indicates a differential Doppler frequency with respect to the reference Doppler frequency for each Doppler frequency measurement of the one or more Doppler frequency measurements for the path or path-group.
Aspect 19: The method of Aspect 16, wherein the Doppler measurement report indicates an index of a path or path-group associated with a reference Doppler frequency, and wherein, for each path or path-group of the one or more paths or path-groups, the Doppler measurement report indicates a relative Doppler frequency with respect to the reference Doppler frequency for each Doppler frequency measurement of the one or more Doppler frequency measurements for the path or path-group.
Aspect 20: The method of any of Aspects 12-19, wherein the Doppler measurement report indicates, for each path or path-group of the one or more paths or path-groups, respective Doppler frequency bins of the Doppler frequency quantization for each of one or more Doppler frequency measurements for the path or path-group, a number of the one or more Doppler frequency measurements for the path or path-group, and an index for with a path or path-group associated with a reference Doppler frequency.
Aspect 21: The method of any of Aspects 1-20, wherein the Doppler measurement report indicates a respective Doppler frequency power measurement for each path or path-group of the one or more paths or path-groups.
Aspect 22: The method of any of Aspects 1-21, wherein the Doppler measurement report indicates, for each path or path-group of the one or more paths or paths-groups, one or more Doppler frequency measurements for the path or path-group and a respective Doppler frequency power measurement for Doppler frequency measurement of the one or more Doppler frequency measurements for the path or path-group.
Aspect 23: The method of any of Aspects 1-22, wherein the Doppler measurement report indicates an index for a path or path-group associated with a strongest Doppler frequency power measurement, among the one or more paths or path-groups, and wherein the Doppler measurement report indicates a respective power ratio or power differential, with respect to the strongest Doppler frequency power measurement, for each of one or more Doppler frequency power measurements for each path or path-group of the one or more paths or path-groups.
Aspect 24: The method of any of Aspects 1-23, wherein the Doppler measurement report is included in uplink control information (UCI).
Aspect 25: The method of Aspect 24, wherein the Doppler measurement report is included in UCI part 2 or UCI part 3 of a channel state information (CSI) report.
Aspect 26: A method of wireless communication performed by a network entity, comprising: transmitting a Doppler measurement report configuration; transmitting a tracking reference signal (TRS); and receiving a Doppler measurement report associated with a user equipment (UE) in accordance with the Doppler measurement report configuration, wherein the Doppler measurement report indicates per path or per path-group Doppler frequency and Doppler frequency power measurements performed on the TRS, for one or more paths or path-groups.
Aspect 27: The method of Aspect 26, wherein the TRS is a channel state information (CSI) reference signal (CSI-RS) for tracking, the Doppler measurement report configuration is a CSI report configuration, and the Doppler measurement report is a CSI report.
Aspect 28: The method of any of Aspects 26-27, wherein the Doppler measurement report indicates, for each path or path-group of the one or more paths or path-groups, a time index associated with the path or path-group, one or more Doppler frequency measurements for the path or path-group, and one or more Doppler frequency power measurements for the path or path group.
Aspect 29: The method of any of Aspects 26-28, wherein the one or more paths or path-groups, for which the per path or per path-group Doppler frequency and Doppler frequency power measurements are indicated in the Doppler measurement report, are included in a plurality of paths within a time window associated with the TRS, and wherein a resolution of each path of the plurality of paths is based at least in part on a bandwidth of the TRS.
Aspect 30: The method of Aspect 29, wherein the Doppler measurement report configuration indicates a start of the time window with respect to a downlink reference time associated with the TRS and a length of the time window.
Aspect 31: The method of any of Aspects 29-30, wherein the Doppler measurement report configuration indicates a cluster resolution for clustering the plurality of paths into path-groups.
Aspect 32: The method of Aspect 31, wherein the Doppler measurement report configuration includes a configured value for the cluster resolution, or wherein the Doppler measurement report configuration indicates, by absence of the configured value for the cluster resolution, a default value for the cluster resolution.
Aspect 33: The method of any of Aspects 29-32, wherein the Doppler measurement report configuration indicates a maximum number of the one or more paths or path-groups for which the per path or per path-group Doppler frequency and Doppler frequency measurements are indicated in the Doppler measurement report and a threshold for identifying the one or more paths or path-groups for which the per path or per path-group Doppler frequency and Doppler frequency power measurements are indicated in the Doppler measurement report.
Aspect 34: The method of Aspect 33, wherein the threshold for identifying the one or more paths or path-groups is a power threshold.
Aspect 35: The method of Aspect 33, wherein the threshold for identifying the one or more paths or path-groups is a Doppler frequency threshold.
Aspect 36: The method of any of Aspects 33-35, wherein the Doppler measurement report includes a number of the one or more paths or path-groups for which the per path or per path-group Doppler frequency and Doppler frequency power measurements are indicated in the Doppler measurement report, indications of indexes for the one or more paths or path-groups, and an indication of an index for a strongest path or path-group of the one or more paths or path-groups.
Aspect 37: The method of any of Aspects 26-36, wherein the Doppler measurement report configuration indicates a Doppler frequency range and Doppler frequency quantization for reporting Doppler frequency measurements for the one or more paths or path-groups in the Doppler measurement report, and a number of Doppler frequency measurements to be reported in the Doppler measurement report for each path or path-group of the one or more paths or path-groups.
Aspect 38: The method of Aspect 37, wherein the Doppler frequency quantization is a uniform quantization with a plurality of Doppler frequency bins having a same bin resolution.
Aspect 39: The method of Aspect 37, wherein the Doppler frequency quantization is a non-uniform quantization with a plurality of Doppler frequency bins with non-uniform bin resolutions.
Aspect 40: The method of any of Aspects 37-39, wherein the Doppler measurement report configuration further indicates a scaling factor for scaling the Doppler frequency range and the Doppler frequency quantization.
Aspect 41: The method of any of Aspects 37-40, wherein the Doppler measurement report indicates, for each path or path-group of the one or more paths or path-groups, one or more Doppler frequency measurements for the path or path-group in accordance with the Doppler frequency quantization.
Aspect 42: The method of Aspect 41, wherein for each path or path-group of the one or more paths or path-groups, the Doppler measurement report indicates a measured Doppler frequency for each Doppler frequency measurement of the one or more Doppler frequency measurements for the path or path-group.
Aspect 43: The method of Aspect 41, wherein the Doppler measurement report indicates an index of a path or path-group associated with a reference Doppler frequency, and wherein, for each path or path-group of the one or more paths or path-groups, the Doppler measurement report indicates a differential Doppler frequency with respect to the reference Doppler frequency for each Doppler frequency measurement of the one or more Doppler frequency measurements for the path or path-group.
Aspect 44: The method of Aspect 41, wherein the Doppler measurement report indicates an index of a path or path-group associated with a reference Doppler frequency, and wherein, for each path or path-group of the one or more paths or path-groups, the Doppler measurement report indicates a relative Doppler frequency with respect to the reference Doppler frequency for each Doppler frequency measurement of the one or more Doppler frequency measurements for the path or path-group.
Aspect 45: The method of any of Aspects 37-44, wherein the Doppler measurement report indicates, for each path or path-group of the one or more paths or path-groups, respective Doppler frequency bins of the Doppler frequency quantization for each of one or more Doppler frequency measurements for the path or path-group, a number of the one or more Doppler frequency measurements for the path or path-group, and an index for with a path or path-group associated with a reference Doppler frequency.
Aspect 46: The method of any of Aspects 26-45, wherein the Doppler measurement report indicates a respective Doppler frequency power measurement for each path or path-group of the one or more paths or path-groups.
Aspect 47: The method of any of Aspects 26-46, wherein the Doppler measurement report indicates, for each path or path-group of the one or more paths or paths-groups, one or more Doppler frequency measurements for the path or path-group and a respective Doppler frequency power measurement for Doppler frequency measurement of the one or more Doppler frequency measurements for the path or path-group.
Aspect 48: The method of any of Aspects 26-47, wherein the Doppler measurement report indicates an index for a path or path-group associated with a strongest Doppler frequency power measurement, among the one or more paths or path-groups, and wherein the Doppler measurement report indicates a respective power ratio or power differential, with respect to the strongest Doppler frequency power measurement, for each of one or more Doppler frequency power measurements for each path or path-group of the one or more paths or path-groups.
Aspect 49: The method of any of Aspects 26-48, wherein the Doppler measurement report is included in uplink control information (UCI).
Aspect 50: The method of Aspect 49, wherein the Doppler measurement report is included in UCI part 2 or UCI part 3 of a channel state information (CSI) report.
Aspect 51: An apparatus for wireless communication at a device, comprising a processor; memory coupled with the processor; and instructions stored in the memory and executable by the processor to cause the apparatus to perform the method of one or more of Aspects 1-25.
Aspect 52: A device for wireless communication, comprising a memory and one or more processors coupled to the memory, the one or more processors configured to perform the method of one or more of Aspects 1-25.
Aspect 53: An apparatus for wireless communication, comprising at least one means for performing the method of one or more of Aspects 1-25.
Aspect 54: A non-transitory computer-readable medium storing code for wireless communication, the code comprising instructions executable by a processor to perform the method of one or more of Aspects 1-25.
Aspect 55: A non-transitory computer-readable medium storing a set of instructions for wireless communication, the set of instructions comprising one or more instructions that, when executed by one or more processors of a device, cause the device to perform the method of one or more of Aspects 1-25.
Aspect 56: An apparatus for wireless communication at a device, comprising a processor; memory coupled with the processor; and instructions stored in the memory and executable by the processor to cause the apparatus to perform the method of one or more of Aspects 26-50.
Aspect 57: A device for wireless communication, comprising a memory and one or more processors coupled to the memory, the one or more processors configured to perform the method of one or more of Aspects 26-50.
Aspect 58: An apparatus for wireless communication, comprising at least one means for performing the method of one or more of Aspects 26-50.
Aspect 59: A non-transitory computer-readable medium storing code for wireless communication, the code comprising instructions executable by a processor to perform the method of one or more of Aspects 26-50.
Aspect 60: A non-transitory computer-readable medium storing a set of instructions for wireless communication, the set of instructions comprising one or more instructions that, when executed by one or more processors of a device, cause the device to perform the method of one or more of Aspects 26-50.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive, from a network entity, a Doppler measurement report configuration;
receive, from the network entity, a tracking reference signal (TRS); and
transmit, to the network entity, a Doppler measurement report in accordance with the Doppler measurement report configuration, wherein the Doppler measurement report indicates per path or per path-group Doppler frequency and Doppler frequency power measurements performed on the TRS, for one or more paths or path-groups.

2. The UE of claim 1, wherein the Doppler measurement report indicates, for each path or path-group of the one or more paths or path-groups, a time index associated with the path or path-group, one or more Doppler frequency measurements for the path or path-group, and one or more Doppler frequency power measurements for the path or path group.

3. The UE of claim 1, wherein the one or more paths or path-groups, for which the per path or per path-group Doppler frequency and Doppler frequency power measurements are indicated in the Doppler measurement report, are included in a plurality of paths within a time window associated with the TRS, and wherein a resolution of each path of the plurality of paths is based at least in part on a bandwidth of the TRS.

4. The UE of claim 3, wherein the Doppler measurement report configuration indicates a start of the time window with respect to a downlink reference time associated with the TRS and a length of the time window.

5. The UE of claim 3, wherein the Doppler measurement report configuration indicates a cluster resolution for clustering the plurality of paths into path-groups.

6. The UE of claim 5, wherein the Doppler measurement report configuration includes a configured value for the cluster resolution, or wherein the Doppler measurement report configuration indicates, by absence of the configured value for the cluster resolution, a default value for the cluster resolution.

7. The UE of claim 3, wherein the Doppler measurement report configuration indicates a maximum number of the one or more paths or path-groups for which the per path or per path-group Doppler frequency and Doppler frequency measurements are indicated in the Doppler measurement report and a threshold for identifying the one or more paths or path-groups for which the per path or per path-group Doppler frequency and Doppler frequency power measurements are indicated in the Doppler measurement report.

8. The UE of claim 7, wherein the threshold for identifying the one or more paths or path-groups is a power threshold.

9. The UE of claim 7, wherein the threshold for identifying the one or more paths or path-groups is a Doppler frequency threshold.

10. The UE of claim 7, wherein the Doppler measurement report includes a number of the one or more paths or path-groups for which the per path or per path-group Doppler frequency and Doppler frequency power measurements are indicated in the Doppler measurement report, indications of indexes for the one or more paths or path-groups, and an indication of an index for a strongest path or path-group of the one or more paths or path-groups.

11. The UE of claim 1, wherein the Doppler measurement report configuration indicates a Doppler frequency range and Doppler frequency quantization for reporting Doppler frequency measurements for the one or more paths or path-groups in the Doppler measurement report, and a number of Doppler frequency measurements to be reported in the Doppler measurement report for each path or path-group of the one or more paths or path-groups.

12. The UE of claim 11, wherein the Doppler frequency quantization is a uniform quantization with a plurality of Doppler frequency bins having a same bin resolution.

13. The UE of claim 11, wherein the Doppler frequency quantization is a non-uniform quantization with a plurality of Doppler frequency bins with non-uniform bin resolutions.

14. The UE of claim 11, wherein the Doppler measurement report configuration further indicates a scaling factor for scaling the Doppler frequency range and the Doppler frequency quantization.

15. The UE of claim 11, wherein the Doppler measurement report indicates, for each path or path-group of the one or more paths or path-groups, one or more Doppler frequency measurements for the path or path-group in accordance with the Doppler frequency quantization.

16. The UE of claim 15, wherein for each path or path-group of the one or more paths or path-groups, the Doppler measurement report indicates a measured Doppler frequency for each Doppler frequency measurement of the one or more Doppler frequency measurements for the path or path-group.

17. The UE of claim 15, wherein the Doppler measurement report indicates an index of a path or path-group associated with a reference Doppler frequency, and wherein, for each path or path-group of the one or more paths or path-groups, the Doppler measurement report indicates a differential Doppler frequency with respect to the reference Doppler frequency for each Doppler frequency measurement of the one or more Doppler frequency measurements for the path or path-group.

18. The UE of claim 15, wherein the Doppler measurement report indicates an index of a path or path-group associated with a reference Doppler frequency, and wherein, for each path or path-group of the one or more paths or path-groups, the Doppler measurement report indicates a relative Doppler frequency with respect to the reference Doppler frequency for each Doppler frequency measurement of the one or more Doppler frequency measurements for the path or path-group.

19. The UE of claim 11, wherein the Doppler measurement report indicates, for each path or path-group of the one or more paths or path-groups, respective Doppler frequency bins of the Doppler frequency quantization for each of one or more Doppler frequency measurements for the path or path-group, a number of the one or more Doppler frequency measurements for the path or path-group, and an index for with a path or path-group associated with a reference Doppler frequency.

20. The UE of claim 1, wherein the Doppler measurement report indicates a respective Doppler frequency power measurement for each path or path-group of the one or more paths or path-groups.

21. The UE of claim 1, wherein the Doppler measurement report indicates, for each path or path-group of the one or more paths or paths-groups, one or more Doppler frequency measurements for the path or path-group and a respective Doppler frequency power measurement for Doppler frequency measurement of the one or more Doppler frequency measurements for the path or path-group.

22. The UE of claim 1, wherein the Doppler measurement report indicates an index for a path or path-group associated with a strongest Doppler frequency power measurement, among the one or more paths or path-groups, and wherein the Doppler measurement report indicates a respective power ratio or power differential, with respect to the strongest Doppler frequency power measurement, for each of one or more Doppler frequency power measurements for each path or path-group of the one or more paths or path-groups.

23. The UE of claim 1, wherein the Doppler measurement report is included in uplink control information (UCI).

24. The UE of claim 23, wherein the Doppler measurement report is included in UCI part 2 or UCI part 3 of a channel state information (CSI) report.

25. A network entity for wireless communication, comprising:
a memory; and
one or more processors, coupled to the memory, configured to:
transmit a Doppler measurement report configuration;
transmit a tracking reference signal (TRS); and
receive a Doppler measurement report associated with a user equipment (UE) in accordance with the Doppler measurement report configuration, wherein the Doppler measurement report indicates per path or per path-group Doppler frequency and Doppler frequency power measurements performed on the TRS, for one or more paths or path-groups.

26. A method of wireless communication performed by a user equipment (UE), comprising:
receiving, from a network entity, a Doppler measurement report configuration;
receiving, from the network entity, a tracking reference signal (TRS); and
transmitting, to the network entity, a Doppler measurement report in accordance with the Doppler measurement report configuration, wherein the Doppler measurement report indicates per path or per path-group Doppler frequency and Doppler frequency power measurements performed on the TRS, for one or more paths or path-groups.

27. The method of claim 26, wherein the Doppler measurement report indicates, for each path or path-group of the one or more paths or path-groups, a time index associated with the path or path-group, one or more Doppler frequency measurements for the path or path-group, and one or more Doppler frequency power measurements for the path or path group.

28. The method of claim 26, wherein the Doppler measurement report configuration indicates a maximum number of the one or more paths or path-groups for which the per path or per path-group Doppler frequency and Doppler frequency measurements are indicated in the Doppler measurement report and a threshold for identifying the one or more paths or path-groups for which the per path or per path-group Doppler frequency and Doppler frequency power measurements are indicated in the Doppler measurement report.

29. The method of claim 26, wherein the Doppler measurement report configuration indicates a Doppler frequency range and Doppler frequency quantization for reporting Doppler frequency measurements for the one or more paths or path-groups in the Doppler measurement report, and a number of Doppler frequency measurements to be reported in the Doppler measurement report for each path or path-group of the one or more paths or path-groups.

30. A method of wireless communication performed by a network entity, comprising:
transmitting a Doppler measurement report configuration;
transmitting a tracking reference signal (TRS); and
receiving a Doppler measurement report associated with a user equipment (UE) in accordance with the Doppler measurement report configuration, wherein the Doppler measurement report indicates per path or per path-group Doppler frequency and Doppler frequency power measurements performed on the TRS, for one or more paths or path-groups.
